(19) United States
(12) Patent Application Publication
(10) Pub. No.: US 2013/0251146 A1
(43) Pub. Date: Sep. 26, 2013

(54) CONTROL WORD PROTECTION

(71) Applicant: Petrus Lambertus Adrianus Roelse, Hoofddorp (NL)

(72) Inventor: Petrus Lambertus Adrianus Roelse, Hoofddorp (NL)

(73) Assignee: IRDETO B.V., Hoofddorp (NL)

(21) Appl. No.: 13/990,762

(22) PCT Filed: Nov. 30, 2011
(86) PCT No.: PCT/EP2011/071435

§ 371 Date: May 30, 2013

(30) Foreign Application Priority Data
Dec. 1, 2010 (EP) 10193312.5
Jul. 11, 2011 (EP) 11250650.6

(51) Int. Cl. H04N 7/167

(52) U.S. Cl. CPC H04N 7/1675
USPC 380/210

(57) ABSTRACT

A method for securely obtaining a control word in a chip set of a receiver, said control word for descrambling scrambled content received by the receiver, the method comprising, at the chip set: receiving a secured version of a virtual control word from a conditional access/digital rights management client communicably connected to the chip set; obtaining the virtual control word from the secured version of the virtual control word; and using a first cryptographic function to produce a given output from an input that comprises the virtual control word and either a plurality of signature verification keys or one or more values derived from a plurality of signature verification keys, each signature verification key being associated with a conditional access/digital rights management system, the given output comprising at least one control word, wherein the first cryptographic function has the property that it is infeasible to determine a key pair including a signature key and a signature verification key and an input for the first cryptographic function comprising the determined signature verification key or one or more values derived, at least in part, from the determined signature verification key, such that the first cryptographic function produces the given output from the determined input.

### FIELD OF THE INVENTION

The present invention relates to methods and apparatus for securely obtaining a control word in a chip set of a receiver. The present invention also relates to methods and systems for providing a control word to a chip set of a receiver. The present invention also relates to computer programs for carrying out such methods, as well as computer readable media storing such computer programs.

### BACKGROUND OF THE INVENTION

Conditional access/digital rights management (CA/DRM) systems for digital video broadcast (DVB) transmissions are well known and widely used in conjunction with pay television (TV) services. Such systems provide secure transmission of a broadcast stream comprising one or more services to a digital receiver contained for example in a set-top box or a mobile terminal supporting broadcast services. To protect the broadcast services from unauthorized viewing, the data packets are scrambled (encrypted) at the transmitter side with an encryption key commonly referred to as a control word. A CA/DRM system implements the selective distribution of the control words to authorized receivers only. Further security is provided by periodically changing the control words so they are only valid for a certain period. Typically control words are transmitted in encrypted form to the receiver using so-called entitlement control messages (ECMs).

In the receiver an ECM is filtered out of a transport stream and sent to a secure computing environment, referred to as a CA/DRM client (e.g., a CA/DRM client can be a smart card with embedded software or it can be an obfuscated software module executed inside the receiver). The CA/DRM client subsequently decrypts the ECM using a higher-level key, which is common to all CA/DRM clients that are authorized to access the TV channels associated with the control words included in the ECM. The control word is returned to the receiver, which loads the control word into the descrambler for descrambling data.

Control word piracy is a significant problem in digital video broadcasting (DVB) systems. A common attack uses the fact that a control word is a shared key that unlocks content on all receivers. An adversary can break part of the key delivery infrastructure to obtain control words and re-distribute the control words to unauthorized receivers. For instance, sometimes adversaries are able to intercept a control word that is transmitted from the CA/DRM client to the receiver and re-distribute it over local networks or over the Internet. The re-distributed control word is then used to descramble the scrambled services without a legitimate authorized CA/DRM client. A security requirement is therefore that the confidentiality and the authenticity of a control word should be protected.

In some cases, a chip set supports a key hierarchy to secure the control word delivery based on secret keys installed during the manufacturing process. FIG. 1 of the accompanying drawings shows a prior art example of chip set 102 of a receiver to load keys to descramble content. Decryption modules 114, 116 and 118 use encrypted input data and an input key to obtain decrypted output data. The chip manufacturer personalizes the chip set with a pseudo-random secret value for the symmetric chip set unique key CSUK and assigns a non-secret chip set serial number CSSN to the chip set for future identification. Elements 104 and 106 are read-only memory locations, for storing CSSN and CSUK, respectively. Elements 108 and 110 are read-and-write memory locations for temporary storing decrypted output data. As shown, content decoder 112 decodes the descrambled content. Dataflows between elements are indicated by arrows. Labels along the arrows identify the dataflows.

As shown in FIG. 1, a content stream scrambled with control word CW, denoted by {Content}_{CW}, is received in the chip set 102. To provide the control word needed to descramble the content, chip set 102 supports secure loading of the associated CW using input {CW}_{CSLK}, which denotes the CW encrypted with a symmetric chip set load key CSLK. Said CSLK is received at chip set 102 encrypted with the symmetric chip set unique key CSUK, which is denoted by input {CSLK}_{CSUK}. To decrypt {CSLK}_{CSUK}, CSUK is needed. The CSUK and the chip set serial number CSSN associated with the particular chip set are typically pre-installed in memory locations on the chip set (element 104 and element 106, respectively) and cannot be altered. In operation, CSUK is retrieved from secured storage (i.e., element 106) in chip set 102 and is used to decrypt the CSLK from {CSLK}_{CSUK} using decryption module 114. Once decrypted, CSLK is stored in memory (i.e., element 108), and can be used to decrypt {CW}_{CSLK} using decryption module 116. Lastly, the clear control word stored in memory (i.e., element 110) is used by decryption module 118 to descramble incoming scrambled content {Content}_{CW}, such that the content may be decoded by the chip set using content decoder 112. Content decoder 112 can be external to the chip set 102 and is typically a part of the receiver.

Typically, for vertical market receivers, a chip manufacturer supplies a list of (CSSN, CSUK) pairs to a CA/DRM supplier, enabling the loading of a value for the chip set load key CSLK into a chip set, using the method depicted in FIG. 1. Known conditional access systems use a key loading mechanism, such as shown in FIG. 1, by sending an entitlement management message (EMM) and an ECM from a head-end system to the CA/DRM client. For the example in FIG. 1, the EMM includes the CSLK (intended for the CA/DRM client, and protected using the confidential and authentic channel offered by the CA/DRM system) and its encrypted version {CSLK}_{CSUK} (intended for the chip set 102). The ECM includes an encrypted CW. The CA/DRM client provides {CSLK}_{CSUK} to the chip set and may use the CSLK as a key for loading a sequence of control words. That is, the CA/DRM client may use CSLK to re-encrypt a CW included in an ECM, resulting in a message {CW}_{CSLK} that is sent to the chip set 102. Typically, CSLK is unique to a particular combination of CA/DRM client and chip set, and consequently, only that chip set can decrypt {CW}_{CSLK} received from the CA/DRM client (so sharing a CW loading message {CW}_{CSLK} is not possible).

For horizontal market receivers, a CA/DRM system operator shall be able to swap a CA/DRM system. In the solution described above for vertical market receivers, the secret master key associated with the receiver (that is, the key CSUK) is known to a CA/DRM supplier. From a security perspective, this property is undesirable for horizontal market receivers. A reason for this is that the current CA/DRM supplier may publish the secret master key CSUK after the CA/DRM system has been swapped, compromising the security of the receiver. A security requirement for horizontal receivers is therefore that the scheme shall not require that any of the receiver's secrets known to a CA/DRM supplier need to be known to any other CA/DRM supplier. This requirement is not satisfied in the scheme described above.

While the example in FIG. 1 depicts a method that uses symmetric cryptographic algorithms, it is also possible to use asymmetric, or public-key, cryptography as shown in FIG. 2 of the accompanying drawings.

FIG. 2 shows a typical chip set implementing the loading of a control word using an asymmetric cryptographic algorithm to protect the confidentiality of the control word. Chip set 202, associated with chip set serial number CSSN includes element 204 (read-only memory storage location), element 208 and element 210 for storing a key pair (read-and-write memory storage locations), and element 212 for temporarily storing a clear control word (read-and-write memory location). To protect the authenticity of the key pair, preferably element 208 and element 210 are write-once memory locations.

Instead of loading a pair (CSSN, CSUK) during manufacturing and sending the pairs to the CA/DRM suppliers and their operators (as performed in the example shown in FIG. 1), the chip manufacturer of chip set 202 shown in FIG. 2 personalizes chip set 202 by activating key pair personalization module 206 that generates a random key pair consisting of a chip set public key CSPK and a chip set secret key CSSK. The CSPK and CSSK are stored in elements 208 and 210, respectively. Alternatively, the key pair personalization module 206 may be implemented outside the chip set 202 (e.g., in a chip set personalization system available to the chip set manufacturer), and the manufacturer may load CSSK into the chip set 202 during its personalization. After this, the manufacturer can delete CSSK from its system(s).

The manufacturer maintains pairs of numbers, each pair comprising of a chip set serial number CSSN and its associated chip set public key CSPK. The list of (CSSN, CSPK) pairs can be made available to all CA/DRM suppliers. Notice that only the authenticity of these pairs needs to be protected, as the numbers CSSN and CSPK are not secret. The CSPK is used to encrypt a CW that only the receiver with the corresponding CSSK can decrypt (using decryption module 216). That is, the encrypted control word {CW}_{CSPK} is a unique data pattern as no other receiver will generate the same random key pair (CSPK, CSSK), so sharing a CW loading message {CW}_{CSPK} is not possible. The decrypted CW, stored temporarily in element 212 is then used to decrypt {Content}_{CW} by decryption module 218 to produce the descrambled content. The descrambled content is then subsequently decoded using content decoder 214.

The benefit of the public-key solution depicted as in FIG. 2 is that the chip set secret key CSSK does not need to be known to any CA/DRM supplier. However, as CSPK is a public key, it is also available to an adversary. In particular, an adversary can use a CSPK to distribute a given control word CW to the receiver associated with that CSPK, e.g., after CW is compromised from another receiver. That is, this method does not protect the authenticity of a CW loading message.

A second, independent mechanism for protecting the authenticity of a CW loading message may be added to the public-key solution depicted in FIG. 2. For instance, a message authentication code (MAC) can be used to protect the authenticity of a CW loading message {CW}_{CSPK}. A MAC is a symmetric cryptographic technique, based on a secret key K_{MAC} shared between the CA/DRM client and the chip set. In particular, the CA/DRM client uses K_{MAC} as a key to generate a MAC value of a CW loading message {CW}_{CSPK}. The computed MAC value can be appended to the message. After receiving the message and the MAC value, the chip set uses K_{MAC} to verify the MAC value. Alternatively, a method based on public-key cryptography (i.e., an asymmetric digital signature) can be used for protecting the authenticity of a CW loading message {CW}_{CSPK}. In such a solution, the manufacturer loads a public key associated with a digital signature scheme into the receiver during the personalization phase. This public key can be used as a root key of an authenticity mechanism. The receiver can use the authenticity mechanism to verify the authenticity of a CW loading message {CW}_{CSPK}.

However, for both authenticity schemes (symmetric and asymmetric), the master key used for signing a message is a secret key. This implies that the requirement that the scheme shall not require that any of the receiver's secrets known to a CA/DRM supplier need to be known to any other CA/DRM supplier is not satisfied if this master key is distributed to a CA/DRM supplier.

To fulfil this requirement and to protect the confidentiality and authenticity of a control word, the role of the chip manufacturer as a trusted party can be extended (or an additional trusted party can be used). For example, an additional key layer can be introduced in both schemes, and the trusted party can manage the root keys of such a scheme. However, this implies that the trusted party needs to manage (at least) one secret associated with a receiver after its personalization is completed. For liability reasons, this role of the trusted party is not desirable for chip set manufacturers. This implies that an additional trusted party would be needed.

There is a need for an improved solution for loading control words onto chip sets that solves the problems described above. That is, there is a need for a scheme with the following properties: (i) the confidentiality and the authenticity of a CW are protected (ii) CA/DRM systems can use the scheme independently without the need to share a secret key, and (iii) after the personalization of a receiver, the trusted party no longer needs to manage any secret keys associated with the receiver (chip set).

### SUMMARY OF THE INVENTION

According to a first aspect of the invention, there is provided a method for securely obtaining a control word in a chip set of a receiver, said control word for descrambling scrambled content received by the receiver, the method comprising, at the chip set: receiving a secured version of a virtual control word from a conditional access/digital rights management client communicably connected to the chip set; obtaining the virtual control word from the secured version of the virtual control word; and using a first cryptographic function to produce a given output from an input that comprises the virtual control word and either a plurality of signature verification keys or one or more values derived from a plurality of signature verification keys, each signature verification key being associated with a conditional access/digital rights management system, the given output comprising at least one control word, wherein the first cryptographic function has the property that it is infeasible to determine a key pair including a signature key and a signature verification key and an input for the first cryptographic function comprising the determined signature verification key or one or more values derived, at least in part, from the determined signature verification key, such that the first cryptographic function produces the given output from the determined input.

The method may comprise receiving and storing the signature verification keys of the plurality of signature verification keys, wherein said first cryptographic function is arranged to use said stored signature verification keys as a part of the input to the first cryptographic function.

The method may comprise: receiving the plurality of signature verification keys; generating a derived value from the received plurality of signature verification keys; and storing the generated derived value; wherein said first cryptographic function is arranged to use said stored derived value as a part of the input to the first cryptographic function.

The method may comprise: receiving, at the chip set, a secured version of a chip set load key, wherein the secured version of the chip set load key is secured to protect the authenticity and confidentiality of the chip set load key; and obtaining the chip set load key from the secured version of the chip set load key.

The secured version of the virtual control word may be a virtual control word encrypted using the chip set load key; in which case obtaining the virtual control word from the secured version of the virtual control word may comprise using the chip set load key to decrypt the secured version of the virtual control word.

The secured version of the chip set load key may comprise the chip set load key encrypted using a public key associated with the chip set and a signature based on the chip set load key using a signature key associated with a conditional access/digital rights management system, in which case obtaining the chip set load key from the secured version of the chip set load key may comprise: verifying the signature using a signature verification key corresponding to the signature key associated with the conditional access/digital rights management system, wherein the signature verification key is one of the plurality of signature verification keys; and decrypting the encrypted chip set load key using a secret key associated with the chip set, the secret key corresponding to the public key associated with the chip set.

The method may comprise the chip set storing the chip set load key obtained from the secured version of the chip set load key so that the stored chip set load key can be used to decrypt secured versions of virtual control words received by the chip set.

The method may comprise: receiving the plurality of signature verification keys along with the secured version of the virtual control word; and determining whether the signature based on the stored chip set load key was verified using one of the received signature verification keys and, if it is determined that the signature based on the stored chip set load key was not verified using one of the received signature verification keys, not using the stored chip set load key to decrypt the secured version of the virtual control word received by the chip set.

The receiver may be one receiver in a plurality of receivers, each receiver in the plurality of receivers having a corresponding chip set that has an associated secret key, and the secret keys associated with the chip sets of the receivers in the plurality of receivers are different from each other.

According to a second aspect of the invention, there is provided a method for providing a control word to a chip set of a receiver, the control word to enable the receiver to descramble scrambled content transmitted to the receiver, the method comprising: generating a virtual control word at a head-end system; transmitting the virtual control word from the head-end system to a conditional access/digital rights management client via the receiver, wherein the conditional access/digital rights management client is communicably connected to the chip set; using a first cryptographic function to produce a given output from an input that comprises the virtual control word and either a plurality of signature verification keys or one or more values derived from a plurality of signature verification keys, each signature verification key being associated with a conditional access/digital rights management system, the given output comprising at least one control word, wherein the first cryptographic function has the property that it is infeasible to determine a key pair including a signature key and a signature verification key and an input for the first cryptographic function comprising the determined signature verification key or one or more values derived, at least in part, from the determined signature verification key, such that the first cryptographic function produces the given output from the determined input; scrambling content using the control word to produce scrambled content; and transmitting the scrambled content to the chip set.

The receiver may be associated with a conditional access/digital rights management system, in which case the method may comprise transmitting to the chip set a secured version of a chip set load key, wherein the secured version of the chip set load key is secured to protect the authenticity and confidentiality of the chip set load key, the chip set load key to enable the receiver to access the virtual control word.

The secured version of the chip set load key may comprise the chip set load key encrypted using a public key associated with the chip set and a signature based on the chip set load key using a signature key associated with the conditional access/digital rights management system associated with the receiver and corresponding to one of the plurality of signature verification keys.

The method may comprise transmitting the control word from the head-end system to a second conditional access/digital rights management client via a second receiver, wherein the second conditional access/digital rights management client is communicably connected to a second chip set of the second receiver.

In the above aspects and embodiments, at least two of the signature verification keys in the plurality of signature verification keys may be associated with the same conditional access/digital rights management system.

In the above aspects and embodiments, at least two of the signature verification keys in the plurality of signature verification keys may be associated with different conditional access/digital rights management systems.

In the above aspects and embodiments, a derived value may be produced by providing the plurality of signature verification keys to a second cryptographic function, wherein the second cryptographic function has the property that it is infeasible to generate a key pair including a signature key and a signature verification key and an input for the second cryptographic function comprising the generated signature verification key such that the second cryptographic function produces that derived value from the generated input.

In the above aspects and embodiments, the one or more derived values may comprise, for each signature verification key in the plurality of signature verification keys, a corresponding cryptographic hash value of that signature verification key.

According to a third aspect of the invention, there is provided a chip set, for a receiver, for securely obtaining a control word, the chip set arranged to carry out a method according to the first aspect of the invention (and embodiments thereof) as set out above.

According to fourth aspect of the invention, there is provided a head-end system of a content delivery network, the head-end system arranged to carry out a method according to the second aspect of the invention (and embodiments thereof) as set out above.

According to a fifth aspect of the invention, there is provided a receiver comprising the chip set according to the third aspect of the invention.

According to a sixth aspect of the invention, there is provided a system comprising the head-end system according to fourth aspect of the invention and one or more chip sets according to the third aspect of the invention.

According to a seventh aspect of the invention, there is provided a computer program which, when executed, carries out a method according to the first or second aspect of the invention (and embodiments thereof) as set out above.

### BRIEF DESCRIPTION OF THE DRAWINGS

Embodiments of the invention will now be described, by way of example only, with reference to the accompanying drawings, in which:

FIG. 1 schematically illustrates a prior art chip set using symmetric cryptography;

FIG. 2 schematically illustrates another prior art chip set using asymmetric cryptography;

FIG. 3 schematically illustrates an exemplary system according to an embodiment of the invention;

FIG. 4 schematically illustrates an example method of using a chip set;

FIG. 5 schematically illustrates a method for use in a head-end system of a content delivery network;

FIG. 6-8 schematically illustrate methods for use in a head-end system of a content delivery network that makes use of DVB SimulCrypt;

FIG. 9 schematically illustrates an example method of using a chip set;

FIGS. 10-12 schematically illustrate modified versions of the systems and methods illustrated, respectively, in FIGS. 7-9;

FIG. 13 schematically illustrates a variation of the chip set of FIG. 12; and

FIGS. 14-18 correspond to FIGS. 6, 7, 8, 10 and 11 respectively and include one or more legacy ECM generators and one or more legacy EMM generators.

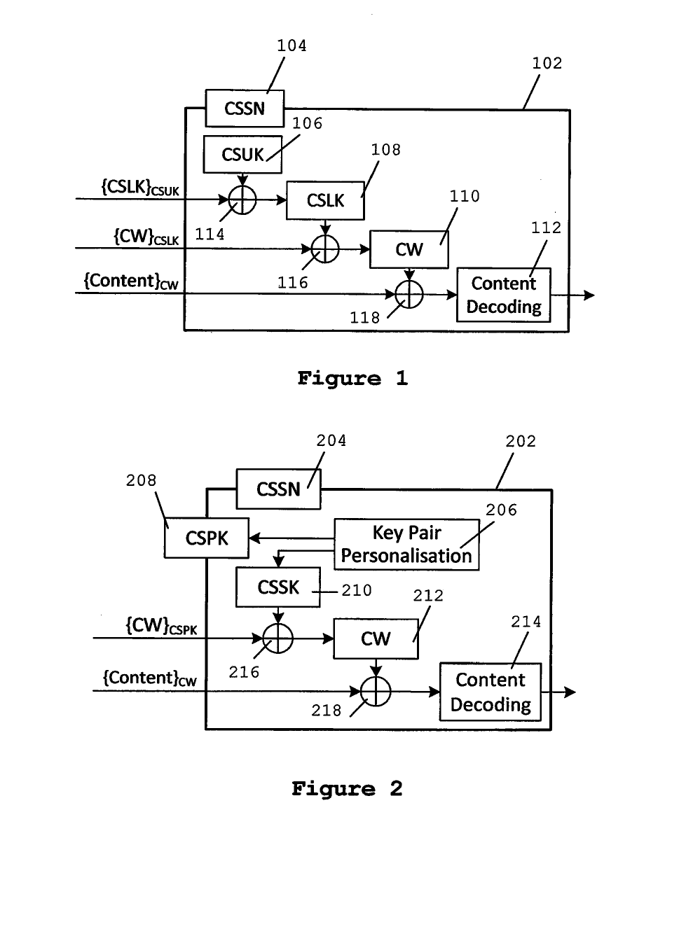

### DETAILED DESCRIPTION OF EMBODIMENTS OF THE INVENTION

In the description that follows and in the Figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

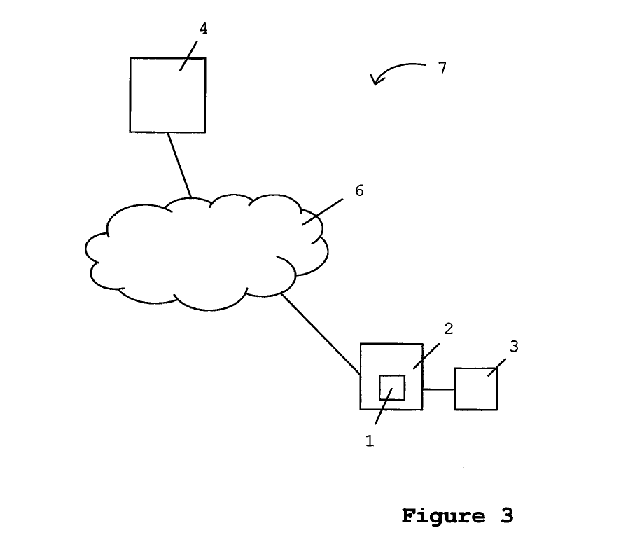

FIG. 3 schematically illustrates an exemplary system 7 according to an embodiment of the invention. The system 7 comprises a head-end system 4 arranged to communicate with one or more receivers 2 via a distribution network 6.

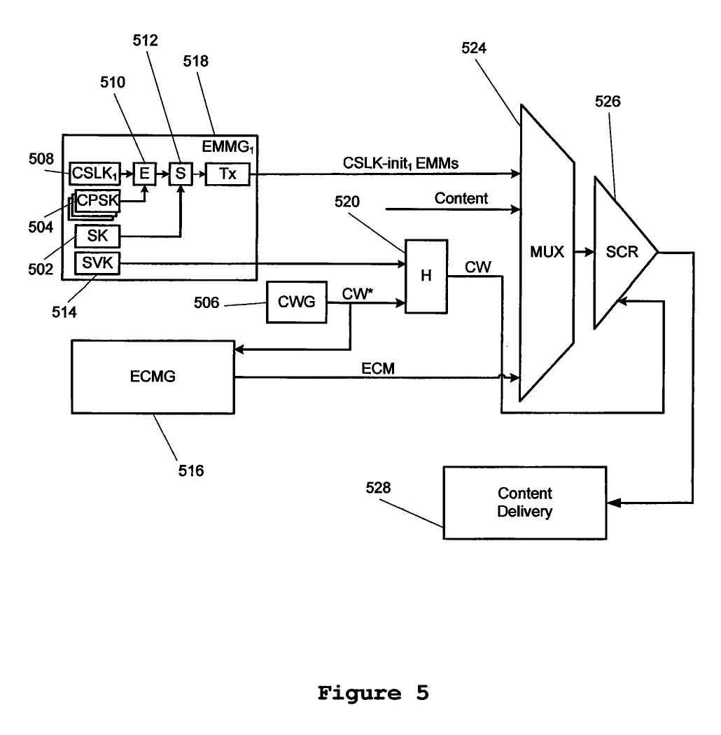

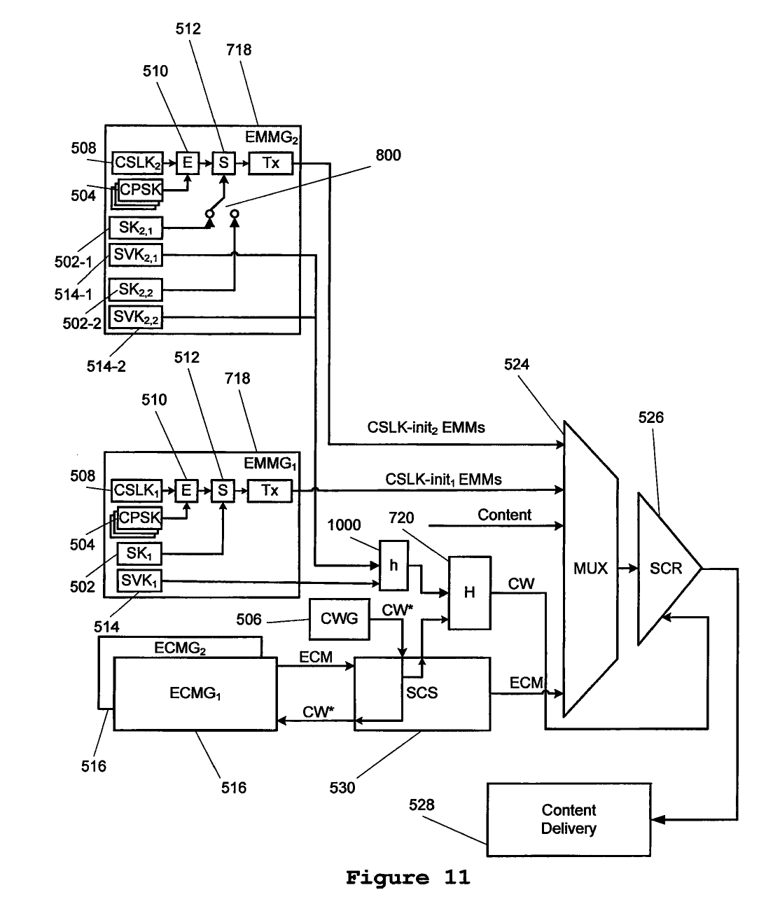

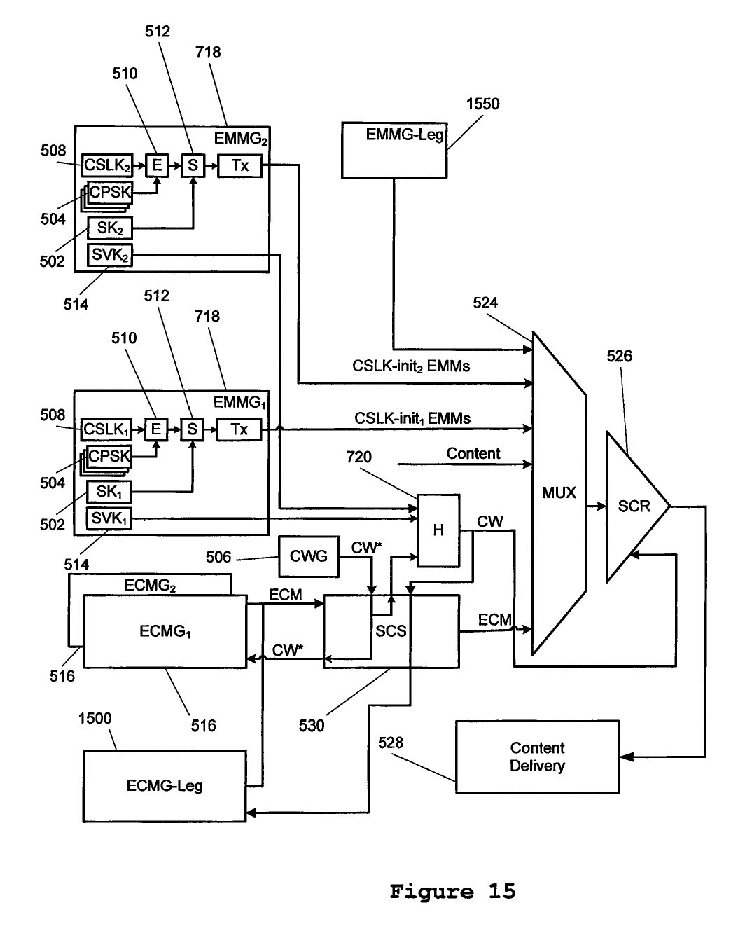

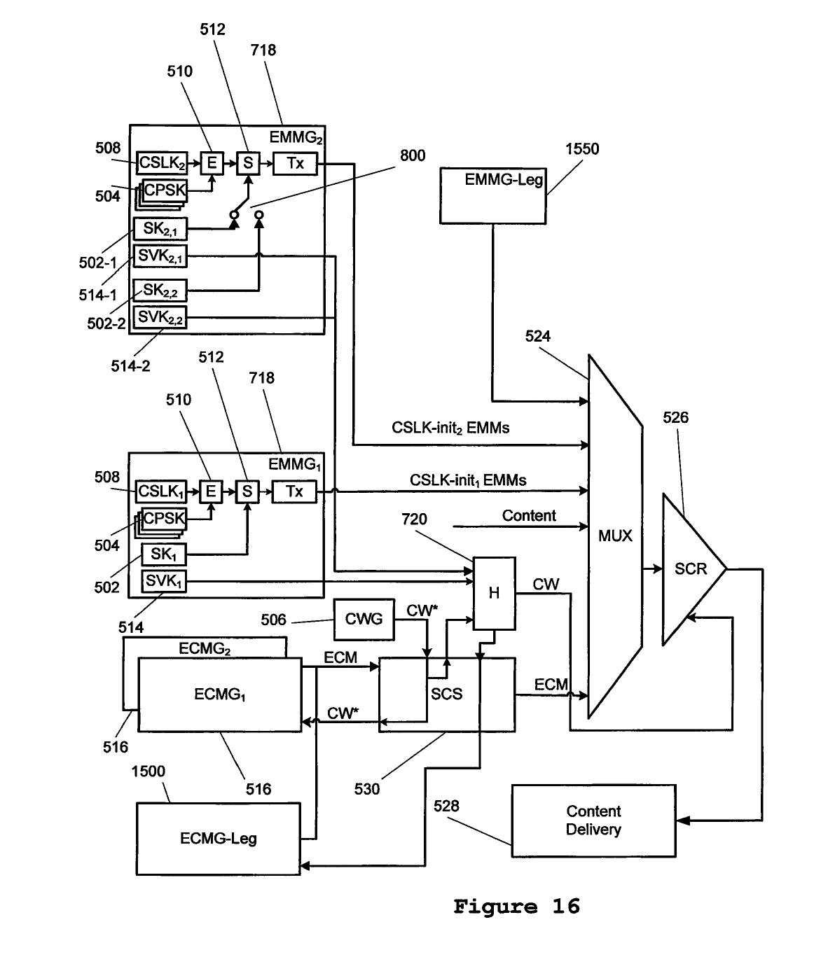

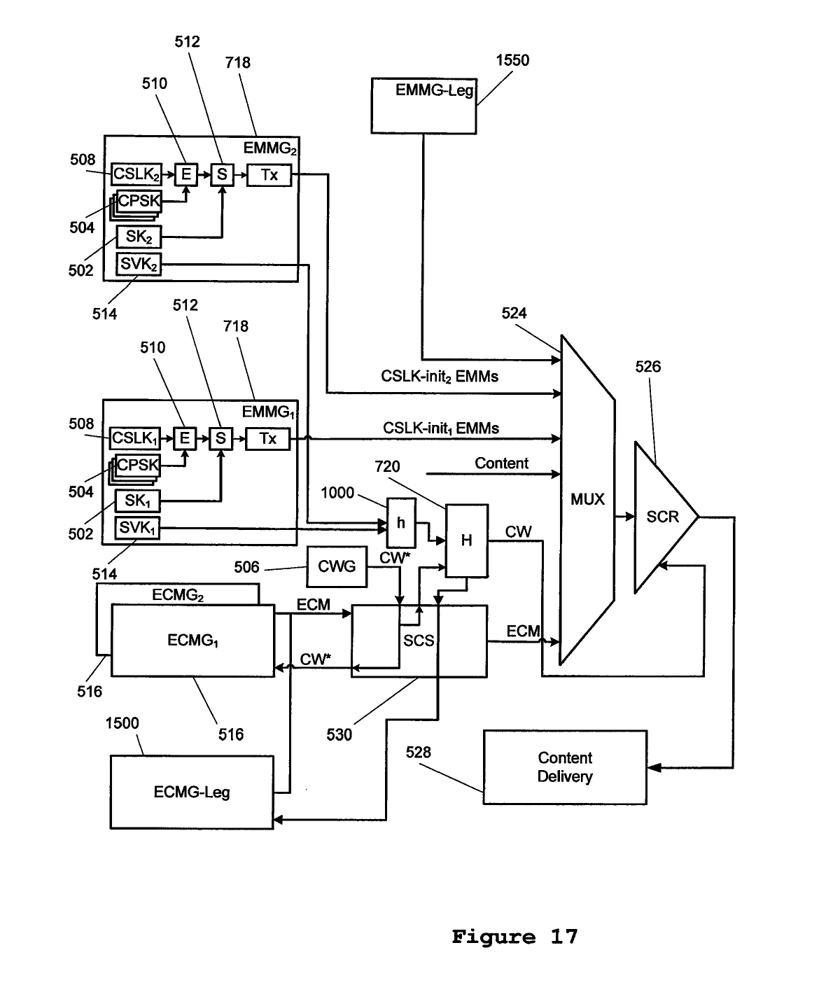

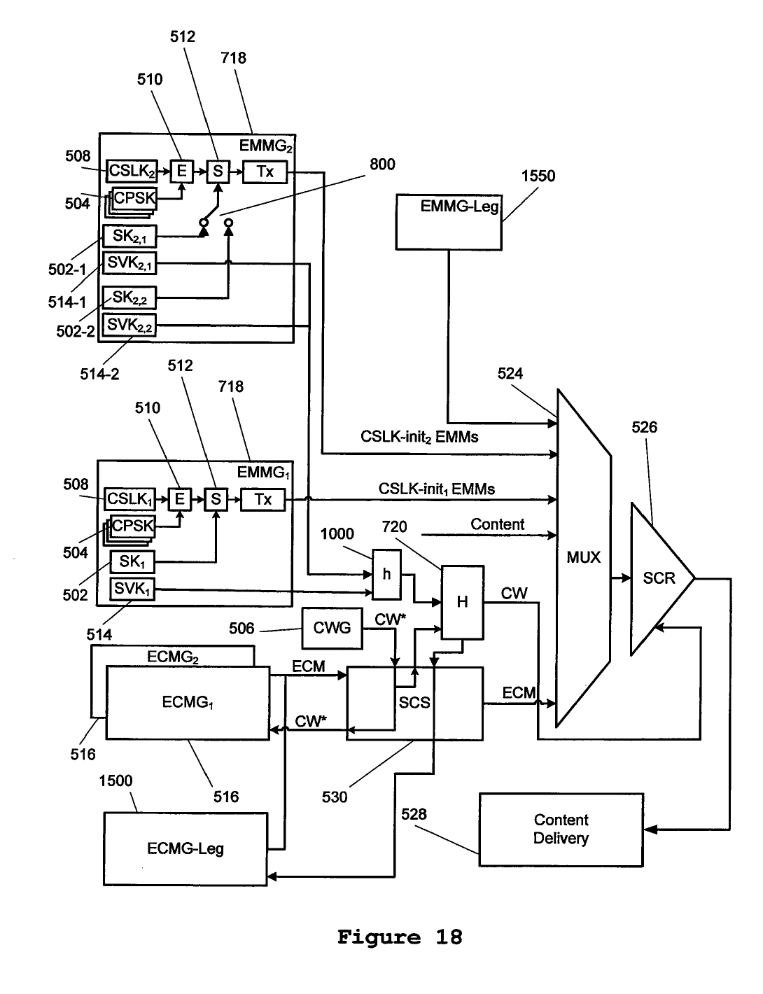

The head-end system 4 transmits (or sends or communicates) a content stream scrambled using one or more control words (i.e. {Content}_{CW}) to a receiver 2 via the distribution network 6. The head-end system 4 may transmit one or more ECMs and EMMs to the receiver 2 via the distribution network 6 so that the receiver 2 can access the one or more control words and thereby descramble the scrambled content stream. It will be appreciated, however, that whilst embodiments of the invention will be described with reference to ECMs and EMMs, embodiments of the invention are not limited to making use of ECMs and EMMS. The head-end system 4 may use any methods and systems described in relation to FIGS. 5-8, 10, 11 and 14-18 to scramble the content and provide descrambling information (e.g. ECMs and EMMs) to the receiver 2.

The distribution network 6 may be any network capable of communicating or broadcasting descrambling information (e.g. ECMs, EMMs) and scrambled content streams to the receiver 2. For example, the distribution network 6 may comprise one or more of a cable network, a satellite communication network, a terrestrial broadcast network, the internet, etc.

The (scrambled) content stream may comprise any kind of content data, such as one or more of video data, audio data, image data, text data, application/software data, program guide data, etc.

The receiver 2 may be any type of receiver (or client device) for receiving ECMs, EMMs and scrambled content streams. For example, the receiver 2 may be a set-top box, a receiver integrated into a content output device (such as a television or radio), a mobile terminal supporting broadcast services, a personal computer, etc. The receiver 2 may include, or be communicatively coupled to, a device for outputting or reproducing descrambled and decoded content to a user (such as a screen/monitor and/or one or more speakers).

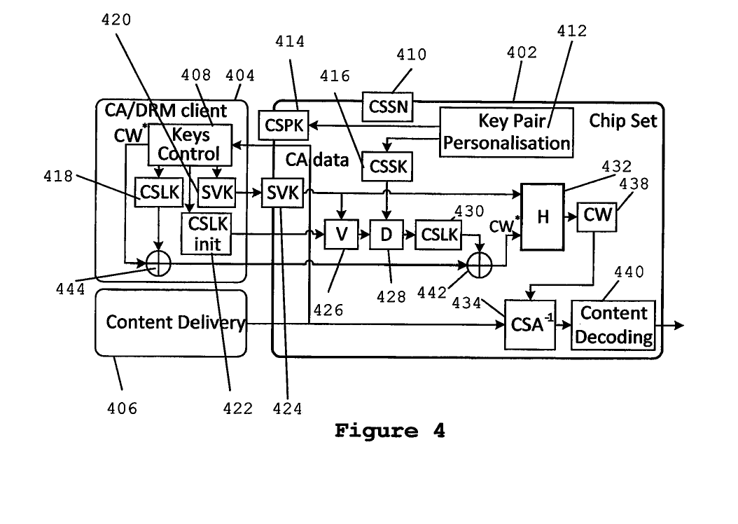

The receiver 2 includes a chip set 1 for descrambling and/or decoding scrambled and/or encoded content. The chip set 1 may be communicatively connected to a CA/DRM client 3. In general, the receiver 2 receives, filters and forwards ECMs and EMMs to the CA/DRM client 3 for further processing. The CA/DRM client 3 accesses conditional access (CA) data from the received ECMs and EMMs and can then load control words onto the chip set 1 using any methods and systems as described in relation to FIGS. 4, 9, 12 and 13. The CA/DRM client 3 may be a secure device removable from the receiver 2, such as a smart card (and may therefore comprise a processor and memory for carrying out the CA/DRM client functionality to be described below). Additionally or alternatively, the CA/DRM client 3 may be integral with the receiver 2 and may be implemented as a hardware component of the receiver 2 and/or in software running in a secured environment of the receiver 2 and/or in obfuscated software running in the receiver 2.

The bandwidth required for transmitting conditional access messages (EMMs and/or ECMs) using the methods and systems described below is comparable to the bandwidth required by existing mechanisms to securely load control words onto a chip set. This is important as bandwidth is a valuable resource and the solutions described below ought not degrade the overall performance of the system 7. The methods and systems described below provide a solution for protecting the confidentiality and authenticity of a control word that allows every CA/DRM system and CA/DRM system operator to establish a key loading mechanism independently, that is, without the need to share any secrets between CA/DRM systems (with the obvious exception of sharing control words in a SimulCrypt operation, as control words are, by definition, shared in a SimulCrypt operation). In addition, no trusted party in the scheme needs to manage any secret associated with a receiver (chip set) after its personalization is completed. This implies that the role of the trusted party is comparable to the role of the chip set manufacturers in currently available vertical market receiver solutions. In addition, the new methods and systems can recover from a security breach in which the root key pair of the authenticity mechanism is compromised, a security feature not offered by existing solutions.

FIG. 4 schematically illustrates an example method of using a chip set. By way of illustration, the method is implemented using a chip set 402 and a CA/DRM client 404. A content delivery module 406 (e.g. of a head-end system 4) may provide conditional access data (such as ECMs and EMMs) and a scrambled content stream to the chip set 402 of a receiver 2. The chip set 402 may pass the conditional access data to the CA/DRM client 404 for further processing.

When manufactured, the chip set 402 may be personalized with a key pair. During the personalisation phase, this key pair is associated with a chip set serial number CSSN. The CSSN may be stored in a memory element 410 of the chip set 402. The key pair includes a chip set public key CSPK (which is stored in a memory element 414 of the chip set 402) and a corresponding chip set secret (private) key CSSK (which is stored in a memory element 416 of the chip set 402). The key pair is preferably generated in the chip set 402 (e.g., using key pair personalisation module 412). Alternatively, the key pair personalization module 412 may be implemented outside the chip set 402 (e.g., in a chip set personalization system available to the chip set manufacturer), and the manufacturer may load CSSK and CSPK into the chip set 402 during its personalization. After this, the manufacturer can delete CSSK from its system(s). As will become apparent, the associated public-key cryptosystem is used to protect the confidentiality of control words needed to descramble scrambled content received by the chip set 402. The use of public-key cryptography allows the chip manufacturer to publish both the CSSN and the CSPK for every chip set that is produced. The manufacturer of the chip sets 402 maintains pairs of numbers, each pair comprising of a chip set serial number CSSN and its associated chip set public key CSPK. The list of (CSSN, CSPK) pairs can be made available to all CA/DRM systems. During the distribution to a CA/DRM system, only the authenticity of this information should preferably be protected.

To prevent an adversary from also using the CSPK to successfully generate and use CW loading messages in a chip set, the systems and methods described below have an additional mechanism that requires the chip set 402 to verify the authenticity of a CW loading message. This mechanism prevents an adversary from issuing control words to the chip set 402 even with the knowledge of the chip set's published CSPK.

The systems and methods described below achieve this by using another asymmetric key pair that is associated with a CA/DRM system associated with the head-end system 4. This key pair includes a (public) signature verification key SVK and a corresponding (secret/private) signature key SK associated with the CA/DRM system. This key pair is for use in an asymmetric cryptographic scheme consisting of a signature generation algorithm and a corresponding signature verification algorithm. The key pair (SK, SVK) is preferably generated by the CA/DRM system associated with the head-end system 4, and its secret key SK does not need to be known to any CA/DRM supplier.

The CA/DRM client 404 may include a communication module for receiving ECMs and/or EMMs and/or other conditional access information forwarded by the chip set 402 and/or the receiver 2. This communication module may be implemented within a keys control module 408 of the CA/DRM client 404. The keys control module 408 may obtain the SVK from conditional access data that it receives from the content delivery module 406 via the chip set 402. SVK may be provided by the head-end system 4 to the CA/DRM client 404.

The signature verification key SVK is stored in a memory element 420 of the CA/DRM client 404. The CA/DRM client 404 may send the signature verification key SVK to the chip set 402 so that the chip set 402 may store the SVK in a memory element 424 of the chip set 402.

As will become apparent from the discussion below, a CA/DRM system associated with the head-end system 4 generates a random value CW* (or interchangeably referred to as a “virtual control word”). The virtual control word CW* is not directly used for (de-)scrambling the content. Instead, a value derivable from CW* and SVK, namely the control word CW, is the key used for (de-)scrambling the content. The head-end system 4 sends the virtual control word CW* to the chip set 402 of the receiver 2 using an ECM. The chip set 402 filters and forwards the received ECM to the CA/DRM client 404 as part of the conditional access data forwarded to the CA/DRM client 404. The keys control module 408 obtains the virtual control word CW* from an ECM that it has received.

The chip set 402 comprises a descrambler 434 for descrambling scrambled content. As mentioned, the chip set 402 does not use CW* directly in the descrambler 434, but derives a CW from CW* and SVK (stored in the memory element 424) using a hash function H implemented by a H-module 432 of the chip set 402. The H-module 432 may merge the two inputs (CW* and SVK) before applying the hash function to the merged inputs to produce the output CW. The H-module 432 may be implemented within a cryptographic/secure module of the chip set 402. The function H may also be any other suitable cryptographic function (i.e. it need not necessarily be a hash function). Possible implementations of the function H preferably have the following property: given an output CW, it is hard (e.g., difficult, computationally difficult, infeasible or computationally infeasible) to find a key pair (SK*, SVK*) and a virtual control word CW** such that SVK* and CW** map to CW (i.e. such that providing SVK* and CW** as inputs to function H, or as inputs to the H-module 432, would result in outputting the control word CW). In certain embodiments, “hard” may mean that an adversary may not be able to derive a key pair (SK*, SVK*) and a virtual control word CW**, such that SVK* and CW** map to CW, in polynomial time or space. In other embodiments, “hard” may be defined by specifying a lower bound on the number of operations or on the size of the memory required to find such values. As a third example, one may define “hard” by specifying an upper-bound on the probability that the property is not satisfied.

An example of a function H with this property is the following: (1) merge the inputs CW* and SVK to produce an intermediate result X, e.g., by appending the value of SVK to the value of CW*, (2) apply a 2^{nd} pre-image resistant hash function to the input X to produce the output CW. To see that the preferred property holds for this example, observe that, given the control word CW and the public key SVK, it will be hard for an adversary to determine an SVK* not equal to SVK, and a virtual control word CW** such that SVK* and CW** map to CW. To see this, assume that it is feasible for an adversary to generate such an SVK* and such a CW**. Then, given the output CW and the inputs SVK and CW*, the same method can be applied to generate a second pre-image comprising of SVK* and CW** to the hash function, as SVK* is not equal to SVK. This implies that the hash function is not 2^{nd} pre-image resistant, contradicting the assumption. As a result, the only option for the adversary is to determine a signature key associated with the public key of the CA/DRM system associated with the head-end system 4 (i.e. SVK) which is, by definition, infeasible for an asymmetric scheme. In addition, notice that the function H satisfies the desired property also in case the virtual control word CW* is known (i.e., in case both inputs to the 2^{nd} pre-image resistant hash function are known). This can be seen as follows: given an output CW and the specified inputs to the 2^{nd} pre-image resistant hash function, it is, by definition, infeasible to determine a second, different set of inputs to the 2^{nd} pre-image resistant hash function that map to the given output CW. This implies that the adversary cannot determine a signature verification key different from SVK that maps to the given CW. The only option for the adversary is to determine a signature key associated with SVK, which is, by definition, infeasible for an asymmetric cryptographic scheme.

After applying, the function H, the H-module 432 stores the output CW in a memory element 438 of the chip set 402. Using CW from the memory element 438, the descrambling module 434 may descramble content provided by the content delivery module 406 and transmit descrambled content to a content decoder 440 of the chip set 402 for further processing (e.g. video or audio decompression). The content decoder 440 may be implemented in the receiver 2 as a module separate from (or external to) the chip set 402.

Symmetric encryption is used to protect the confidentiality and the authenticity of a virtual control word CW*. In particular, a symmetric chip set load key CSLK is generated for a chip set 402 (and is preferably unique to that chip set 402) by a CA/DRM system associated with the head end system 4. The CSLK (intended for the CA/DRM client 404, and protected using the confidential and authentic channel offered by the CA/DRM system) is transmitted along with an initialisation pattern CSLK-init (intended for the chip set 402) to the CA/DRM client 404 connected to the chip set 402. The initialisation pattern CSLK-init includes an encrypted version of CSLK (encrypted using the CSPK of the chip set 402) and, as will be described later, a signature of the encrypted version of CSLK (where the signature is generated using the signature key SK). Hence, the CSLK is encrypted to produce the CSLK-init in such a way that CSLK-init can be processed in the chip set 402 to produce a CSLK value.

In some embodiments, the CSLK (intended for the CA/DRM client 404, and protected using the confidential and authentic channel offered by the CA/DRM system) and the initialization pattern CSLK-init (intended for the chip set 402) are transmitted from the head-end system 4 to the chip set 402 using one or more EMMs, and the chip set 402 may filter out the EMM(s) and forward it/them to the keys control module 408 in the CA/DRM client 404. (If a unique pairing between the CA/DRM client 404 and the chip set 402 is not known within the head-end system 4, then preferably separate EMMs are used for packaging and transmitting CSLK and the initialisation pattern CSLK-init.) The keys control module 408 may then extract CSLK and CSLK-init from the EMM(s) for use by the CA/DRM client 404 and the chip set 402. The CSLK may be stored in a memory element 418 of the CA/DRM client 404 and the CSLK-init may be stored in a memory element 422 of the CA/DRM client 404. The CA/DRM client 404 may subsequently forward the initialisation pattern CSLK-init to the chip set 402.

The CA/DRM client 404 encrypts CW* (that its keys control module 408 has extracted from an ECM that has been forwarded to the keys control module 408) with CSLK (stored in memory element 418) to produce {CW*}_{CSLK} using a symmetric encryption module 444 of the CA/DRM client 404. The encryption of CW* with CSLK may be performed in any suitable security module in the CA/DRM client 404. The encrypted version of CW*, {CW}_{CSLK}, is then transmitted to the chip set 402, where {CW*}_{CSLK} is to be decrypted using a symmetric decryption module 442 of the chip set 402 (corresponding to the symmetric encryption module 444). The decryption module 442 use the CSLK value stored in a memory element 430 of the chip set 404 to obtain CW*.

The initialisation pattern CLSK-init and/or the encrypted version of CW* may be transmitted from the CA/DRM client to chip set 402 using any suitable transmission module in the CA/DRM client 404 communicably connected with the chip set 402. The encrypted version of CW* and/or the initialisation pattern CLSK-init may be received at chip set 402 using yet another communication module in the chip set 402.

To obtain the CSLK value, stored in the memory element 430, for decrypting {CW*}_{CSLK}, the chip set 402 includes two cryptographic operations, implemented as a signature verification module 426 and a decryption module 428. The signature verification module 426 and the decryption module 428 may be implemented in any suitable cryptographic module within the chip set 402. The chip set 402 uses the signature verification module 426 and the SVK of the CA/DRM system associated with the head-end system 4 (stored in the memory element 424 of the chip set 402), to verify the authenticity of CSLK-init. If the signature verification module 426 determines that CSLK-init is not authentic (i.e. if the signature has not been generated using an SK associated with SVK), then the chip set 402 may take any suitable subsequent action to ensure that the user of the receiver 2 does not gain access to decrypted content, such as not performing any content decryption until a new CSLK-init message and/or a new SVK have been received so that the new CSLK-init message can be verified. Alternatively, the signature verification module 426 may output a value from which the decryption module 428 will be able to obtain CSLK only if the verification is successful, i.e. if the CSLK-init has been signed using an SK corresponding to the SVK stored in the memory element 424; otherwise, the signature verification module 426 may output a value from which the decryption module 428 will not be able to obtain CSLK if the verification is not successful, i.e. if the CSLK-init has been not been signed using the SK corresponding to the SVK stored in the memory element 424. For example, a signature mechanism with message recovery may be used.

After verification of the authenticity of CSLK-init, the encrypted CSLK in CSLK-init is decrypted using the CSSK of the chip set 402 (stored in the memory element 416). As the CSLK was encrypted by the CSPK of the chip set 402, only the chip set having the corresponding CSSK may correctly decrypt CSLK from the CSLK-init message.

Once the chip set 402 obtains CSLK, then {CW*}_{CSLK} may be decrypted by the decryption module 442 to obtain CW* using the obtained CSLK. The authenticity of CW* is protected, in that an adversary cannot construct an encrypted CW* message for a given CW* that will produce CW* in the chip set 402 if the authenticity of SVK and the authenticity of the CSLK-init message are protected. The authenticity of the CSLK-init message is protected by signing it with SK. Using the H-module 432 and the SVK value stored in the memory element 424, SVK and CW* may be merged and processed to produce CW. The H-module protects the authenticity of the signature verification key SVK, in that CW descrambling will fail if SVK is not authentic. That is, if the signature verification key of a key pair (SK*, SVK*), determined by an adversary not knowing the signature key SK, is provided as input to the chip set (e.g., to load a CSLK chosen by the adversary, and using this CSLK to load a given CW*), then the H-module 432 will not output the correct CW, and consequently, the content descrambling will fail.

The symmetric chip set load key CSLK is used to decrypt CW* values that are encrypted with a symmetric encryption algorithm and the key CSLK. The H-module 432 suitably derives the CW from the CW* and the SVK, such that CW may be loaded into the descrambling module 434 to descramble content. This implementation has the benefit that the chip set 402 only needs to perform public-key cryptographic operation(s) when processing a CSLK-init message to initially obtain CSLK. During normal operation, CSLK and SVK can be stored inside the chip set, and the CW processing overhead resembles that of the existing systems. The computation step associated with the H-module 432 is comparable to that of a normal symmetric encryption (or decryption) step.

To work with the CA/DRM client/chip set configuration described in relation to FIG. 4, the head-end system 4 is configured to produce the chip set load key initialisation pattern (CSLK-init) for each chip set 402. FIG. 5 schematically illustrates a method for use in such a head-end system 4 of a content delivery network.

Specifically, an EMM generator 518 of the head-end system 4 generates a random chip set load key CSLK for a target chip set 402 (e.g., using a chip set load key generator 508 of the EMM generator 518). The CSLK may be generated using any pseudo-random number generator. Preferably, the EMM generator 518 uses the chip set load key generator 508 to generate a CSLK that is unique to each chip set 402 in a population of chip sets 402—i.e. each receiver 2 being serviced by the CA/DRM system at the head-end system 4 has its own CLSK different from the other receivers 2. This prevents the (unauthorized) sharing of a message {CW*}_{CSLK}.

The EMM generator 518 encrypts the generated CSLK using the CSPK of the target chip set 402 (e.g., using a encryption module 510 of the EMM generator 518).

The EMM generator 518 may comprise a CSPK store 504 that stores the CSPKs of the chip sets 402 being serviced by this CA/DRM system. The encryption module 510 performs an encryption process corresponding to the decryption process performed by the decryption module 428 of the chip set 402.

The EMM generator 518 uses the SK (as stored in memory element 502 of the EMM generator 518) to sign the encrypted CSLK to produce the chip set load key initialisation pattern CSLK-init (e.g., using a signature module 512 of the EMM generator 518). The EMM generator 518 then packages the generated CSLK-init along with the CSLK (intended for the CA/DRM client 404, and protected using the confidential and authentic channel offered by the CA/DRM system) to form an EMM. This EMM is targeted at the CA/DRM client 404 connected to the chip set 402 with the corresponding CSPK or CSSN. If a unique pairing between the CA/DRM client 404 and the chip set 402 is not known within the head-end system 4, then preferably separate EMMs are generated and used for packaging and transmitting CSLK and CSLK-init.

The head-end system 4 includes a CW generator 506 which generates random values for CW*. The CW generator 506 may generate random values for CW* using any pseudo-random number generator.

The head-end system 4 includes an ECM generator 516 that receives a CW* generated by the CW generator 506 and generates an ECM containing the received CW*.

The head-end system 4 includes a multiplexer 524. The multiplexer 524 selects the appropriate data to be transmitted to a CA/DRM module (or scrambling module) 526, choosing at least one of: an ECM output from the ECM generator 516, an EMM output from the EMM generator 518, and content. ECMs and/or EMMs may be passed from the multiplexer 524 to a content delivery module 528 for transmission to the chip set 404. The content passed from the multiplexer 524 is scrambled by the CA/DRM module 526 using CW. This may involve any form of content scrambling technique corresponding to the content descrambling that the content descrambling module 434 is capable of performing. Subsequently, the scrambled content is provided to the content delivery module 528, which transmits the scrambled content to a receiver 2.

The head-end system includes an H-module 520 to produce control words for scrambling content in the CA/DRM module 526. The H-module 520 may be implemented in a cryptographic module. To produce CW, the H-module 520 implements a function H corresponding to the H-module 432 of FIG. 4. In particular, the H-module derives CW from the CW* value that is generated by the CW generator 506 and that is transmitted in an ECM provided by the ECM generator 516. The H-module 520 combines the signature verification key SVK stored in a memory element 514 with CW* generated by the CW generator 506 and applies a function H (e.g. a hash function) to convert the CW* value into CW—the above description (and requirements) of the H-module 432 and the function H of the chip set 402 applies to the H-module 520 and its function H. The H-module 432 of the chip set 404 produces the same output CW as the H-module 520 of the head-end system 4 when they are provided with the same input (SVK and CW*).

The methods and systems described above may be used in a system such as the head-end system described in the DVB SimulCrypt specification (DVB=digital video broadcasting)—see ETSI TS 103 197. The DVB SimulCrypt specification allows two or more CA/DRM systems to share a control word CW as a common key. A common head-end system protocol for facilitating the sharing of the CW streams used in scrambling the digital TV content streams is described in the DVB SimulCrypt specification.

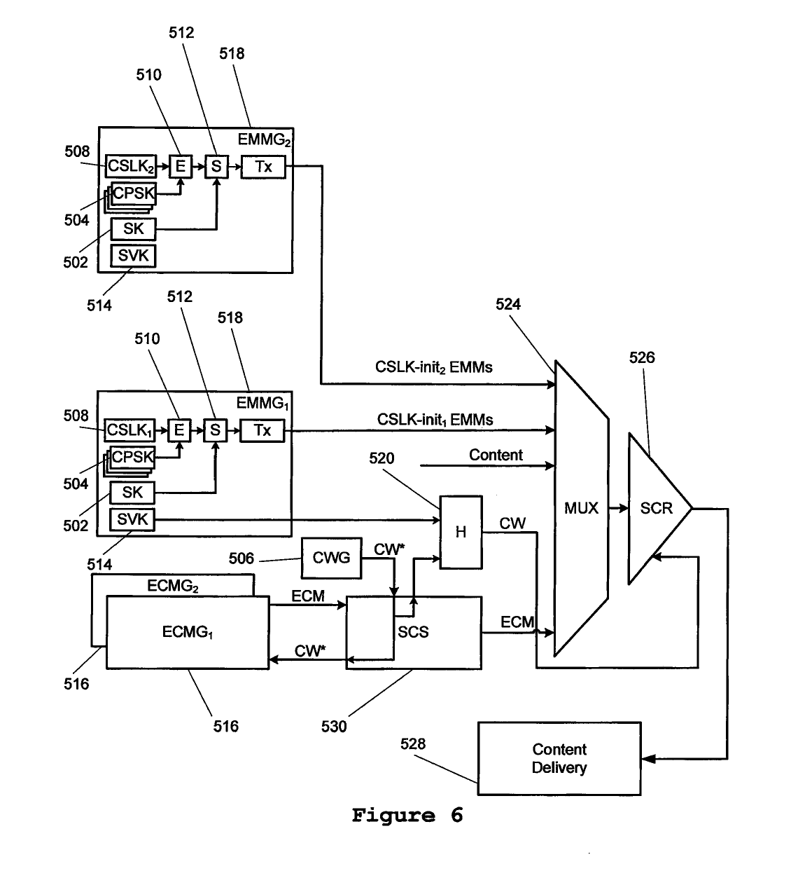

FIG. 6 therefore schematically illustrates a method for use in such a head-end system 4 of a content delivery network that makes use of DVB SimulCrypt. In particular, in FIG. 6 the head-end system 4 comprises two CA/DRM systems that have respective EMM generators 518 (EMMG₁ and EMMG₂) and ECM generators 516 (ECMG₁ and ECMG₂). As is known, a SimulCrypt synchroniser 530 is used to coordinate the multiple ECM generators 516 (for example, by obtaining the CW* output by the CW generator 506, providing the CW* to the ECM generators 516 along with any CA/DRM-specific parameters, acquiring the ECMs from the ECM generators 516, synchronising the timing of the ECMs and their provision to the multiplexer 524). In the normal DVB system as set out in ETSI TS 103 197, the SimulCrypt synchroniser 530 would pass control words to the scrambling module 526—however, as discussed above, it is the H-module 520 which generates the actual control words CW used for content scrambling and passes those generated control words CW to the scrambling module 526 (because the ECMs do not make use of CW but make use of CW* instead)—therefore, in FIG. 6 the SimulCrypt synchroniser 530 is shown as providing CW* to the H-module 520. Hence, a standard SimulCrypt synchroniser 530 may be used, the only difference being that its “control word output” is connected to the H-module 520 instead of directly to the scrambling module 526.

The two CA/DRM systems in FIG. 6 are potentially run or operated by different content providers/CA system operators. It will be appreciated that any number of CA/DRM systems may be associated with the head-end system 4 and that embodiments of the invention are not limited to just two CA/DRM systems.

In the system shown in FIG. 6, the participating CA/DRM systems share the (SK, SVK) pair. In particular, the first EMM generator 518 (EMMG₁) and the second EMM generator 518 (EMMG₂) both have knowledge of, and make use of, the same SK and SVK. In particular, they both generate EMMs for the receivers 2 associated with their respective CA/DRM system as described above, based on a common SK and SVK.

The sharing of a common SK and SVK as set out above has a number of drawbacks. In particular:
A confidential channel between the various CA/DRM systems is required to transport and share the secret key SK. However, a confidential electronic interface between different CA/DRM systems may not exist (especially if the CA/DRM systems are associated with different CA/DRM suppliers). Therefore it would be desirable to let each CA/DRM system generate its own SK(s) and only share the associated (public) signature verification key(s) SVK(s). For instance, such an SK could be generated inside a hardware security module of a CA/DRM system of the head-end system 4 and does not need to be available unprotected at any point in time.
A renewal of the pair (SK, SVK), e.g. after the secret signature key SK has been compromised, has a similar operational impact for all of the CA/DRM systems participating in the SimulCrypt operation and making use of SK. In particular, new CSLK-init EMMs signed with the new signature key have to be generated and distributed for every participating CA/DRM system and all of the receivers 2 that they are servicing. It would be beneficial to limit the operational impact of a renewal of the pair (SK, SVK).

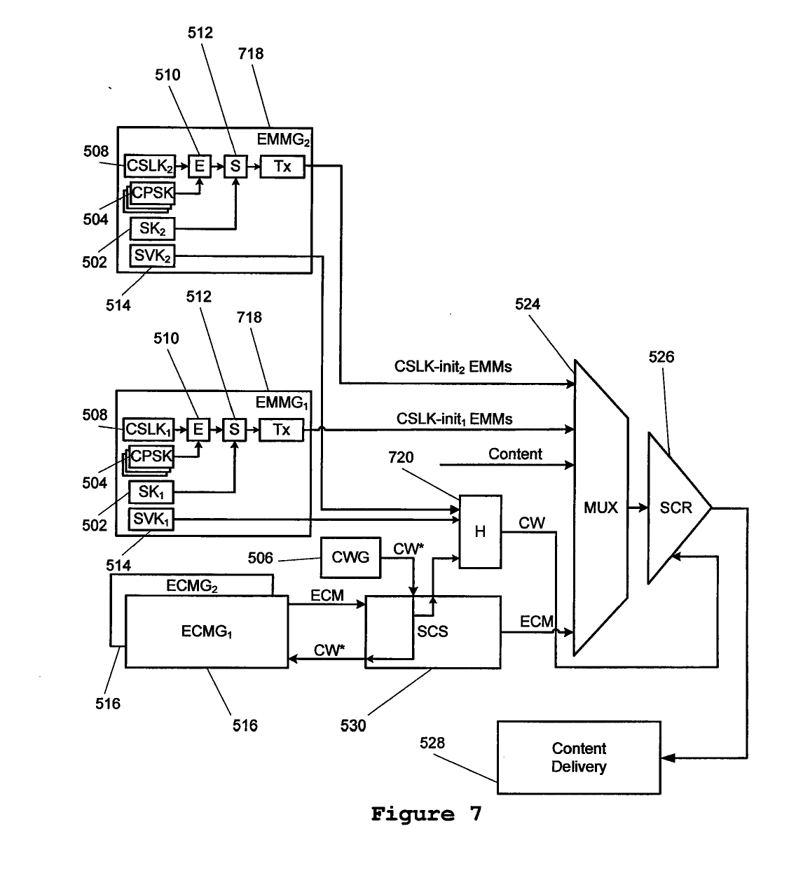

Embodiments of the invention aim to address these issues. FIG. 7 therefore schematically illustrates a method for use in a head-end system 4 of a content delivery network that makes use of DVB SimulCrypt. In particular, in FIG. 7 the head-end system 4 comprises two CA/DRM systems that have respective EMM generators 718 (EMMG₁ and EMMG₂) and ECM generators 516 (ECMG₁ and ECMG₂). This is the same architecture as shown in FIG. 6, except that the EMM generators 718 (EMMG₁ and EMMG₂) comprise and make use of respective signature keys SK₁, SK₂ and corresponding respective signature verification keys SVK₁, SVK₂. In particular, the first CA/DRM system has its own signature key SK₁ and its own corresponding signature verification key SVK₁, whilst the second CA/DRM system has its own (different) signature key SK₂ and its own corresponding signature verification key SVK₂. Each CA/DRM system independently generates its own pair (SKᵢ, SVKᵢ) and can keep its signature key SKᵢ secret from all of the other CA/DRM systems—it needs only to publish the signature verification key SVKᵢ. Recall that this a public key, so its confidentiality does not need to be protected. This implies that there is no longer a need for a protected interface between CA/DRM systems in a SimulCrypt operation.

As with FIG. 6, the two CA/DRM systems in FIG. 7 are potentially run or operated by different content providers/CA system operators. It will be appreciated that in the system shown in FIG. 7, any number of CA/DRM systems may be associated with the head-end system 4 and that embodiments of the invention are not limited to just two conditional access end-systems. Hence, in general, there may be n CA/DRM systems and hence n different respective pairs (SKᵢ, SVKᵢ).

The H-module 520 of FIG. 6 is replaced by an H-module 720 in the system shown in FIG. 7. In particular, as each CA/DRM system now has its own signature verification key SVKᵢ, the H-module 720 is arranged to receive the set of signature verification keys SVKᵢ, . . . , SVKₙ and the CW* output from the CW generator 506. The H-module 720 implements a similar function H as the H-module 520, except that the security requirements are modified to cater for the fact that the H-module 720 operates on a set (or a plurality) of signature verification keys SVK₁, . . . , SVKₙ. In particular, the H-module 720 may merge the inputs CW*, SVK₁, . . . , SVKₙ and may then apply a hash function to the merged inputs to produce the output CW. The function H may also be any other suitable cryptographic function (i.e. it need not necessarily be a hash function). Possible implementations of the function H preferably have the following property: given CW, it is hard (e.g., difficult, computationally difficult, infeasible or computationally infeasible) to find or calculate or determine a key pair (SK*, SVK*) and an input to the function H, such that the determined signature verification key SVK* is a signature verification key in the determined input to H, and such that CW is the output of H for this input (i.e. such that providing that input to function H, or as an input to the H-module 720, would result in outputting the control word CW). In certain embodiments, “hard” may mean that an adversary may not be able to derive such an input in polynomial time or space. In other embodiments, “hard” may be defined by specifying a lower bound on the number of operations or on the size of the memory required to find such an input. As a third example, one may define “hard” by specifying an upper-bound on the probability that the property is not satisfied.

An example of a function H with this property is the following: (1) merge the inputs CW*, SVK₁, . . . , SVKₙ to produce an intermediate result X, e.g., by concatenating these values, (2) apply a 2^{nd} pre-image resistant hash function to the input X to produce the output CW. The analysis provided above when discussing the function H that accepts only a single SVK applies analogously to this modified function H that accepts a set of signature verification keys.

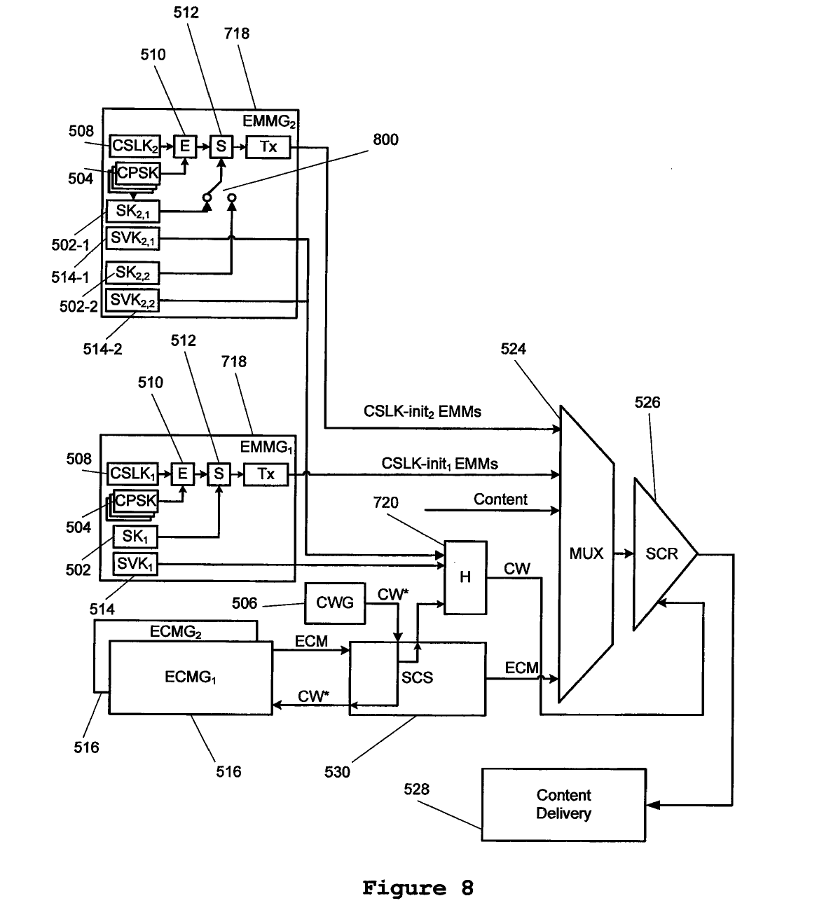

FIG. 8 schematically illustrates a further method for use in a head-end system 4 of a content delivery network that makes use of DVB SimulCrypt. The system and method illustrated in FIG. 8 are the same as those illustrated in FIG. 7, except that one of the CA/DRM systems has a plurality of pairs (SK_{i,j}, SVK_{i,j}). In particular, in FIG. 8, the second CA/DRM system has a first pair (SK_{2,1}, SVK_{2,1}) and a second pair (SK_{2,2}, SVK_{2,2}). However, it will be appreciated that a CA/DRM system may have any number of pairs (SK_{i,j}, SVK_{i,j}) of signature keys and corresponding signature verification keys. The EMM generator (EMMG₂) for the second CA/DRM system may comprise a switch 800 (or some other determining means) for selecting a particular SK_{2,j} (out of the signature keys: SK_{2,1} and SK_{2,2}, associated with that CA/DRM system) to use when carrying out the signature process to generate CSLK-init EMMs.

It will be appreciated that any number of CA/DRM systems associated with the head-end system 4 may have a plurality of associated pairs (SK_{i,j}, SVK_{i,j}) of signature keys and corresponding signature verification keys. Thus, in general, if there are m) CA/DRM systems associated with a head-end system 4, and if the i-th (i=1 . . . m) CA/DRM system has nᵢ (nᵢ≧1) associated pairs (SK_{i,j}, SVK_{i,j}) of signature keys and corresponding signature verification keys, then there are

$$n = {\sum }_{i = 1}^{m} {n}_{i}$$

pairs (SK_{i,j}, SVK_{i,j}) of signature keys and corresponding signature verification keys. The H-module 720 receives the n signature verification keys SVK_{i,j} from the CA/DRM systems as its input, along with the generated virtual control word CW*, and generates a control word CW as described above for FIG. 7.

As each CA/DRM system of FIGS. 7 and 8 uses signature keys (and associated signature verification keys) specific to that CA/DRM system (i.e. two CA/DRM systems do not use the same signature key), a content provider/CA system operator can change the key pair of one CA/DRM system without a significant impact on the other CA/DRM systems (possibly operated by another content provider/CA system operator). More precisely, when a CA/DRM system updates a pair (SK_{i,j}, SVK_{i,j}) with a pair (SK, SVK), then: (a) the EMM generator of that CA/DRM system needs to generate and distribute new CSLK-init EMMs (containing CSLK values, and a signature based on the updated signature key SK) for the receivers 2 associated with this CA/DRM system; (b) the other CA/DRM systems should be made aware of the new signature verification key SVK; (c) all CA/DRM systems should distribute the new signature verification key SVK to all their associated receivers (because, as will be described below, the receivers will need access to the new signature verification key). In a broadcast network, this distribution is generally very bandwidth efficient, as the message containing the new signature verification key SVK can be identical for all receivers.

Hence, if one CA/DRM system updates/renews a key pair (SK_{i,j}, SVK_{i,j}) (e.g., after the signature key SK_{i,j} is compromised) with an updated (SK, SVK) pair, then the impact on the other CA/DRM systems in the SimulCrypt operation is minimal. Moreover, if the signature key SK_{i,j} is compromised, then the head-end security of the other CA/DRM systems is not compromised as their own signature keys are not the same as the compromised signature key. These other CA/DRM systems simply need to be made aware of the new updated signature verification key SVK and these other CA/DRM systems need to make the receivers 2 that they service also aware of the new updated signature verification key SVK, which is a straightforward operation for these other CA/DRM systems. If the signature key SK_{i,j} is compromised, then receiver security is restored for all CA/DRM systems in the SimulCrypt operation as soon as the updated signature verification key SVK is used as input to the H-module (instead of using SVK_{i,j}), revoking the compromised signature key SK_{i,j}.

If a CA/DRM system operator wants to renew a key pair (SK_{i,j}, SVK_{i,j}) with a new key pair (SK, SVK), then switching to the new key pair happens simultaneously for all receivers 2 in a operator's population of receivers 2 (as the control words generated to scramble content will be based on the updated SVK, via the H-module 720, at the point of switching over to the new key pair). From an operational point of view, there is a risk that not all these receivers 2 have received all required information (via EMMs) when the provider starts using the new key pair (more precisely: the new SVK, a receiver's unique CSLK-init pattern signed with the new SK, or a CSLK intended for the CA/DRM client might not have been transmitted to, or received at, a receiver 2 via an EMM when the new SVK is used to generate control words). This can potentially cause a number of receivers to “black-out” for a while as they will not be able to successfully descramble content (as they will not be able to use the updated CSLK messages or the updated SVK). However, CA/DRM systems that have a plurality of associated (SK_{i,j}, SVK_{i,j}) pairs have the following advantage. A first (current) key pair (SK_{i,j}, SVK_{i,j}) can be used to generate CSLK-init pattern messages, that is, the signature key SK_{i,i}, is used to sign CSLK-init patterns. The signature key SK_{i,k} of a second key pair (SK_{i,k}, SVK_{i,k}) is reserved for future use (securely storing the key SK_{i,k}). The signature verification keys of both the first and second pair (that is, SVK_{i,j} and SVK_{i,k}) are used by the H-module 720 to generate control words CW for scrambling content. Suppose that the operator wants to revoke the first key pair (SK_{i,j}, SVK_{i,j}) (e.g., in case the signature key SK_{i,j} is compromised). First, the CA/DRM system retrieves SK_{i,k} from secure storage. Next, the CA/DRM system generates new CSLK-init EMMs, using SK_{i,k} as the signature key (if CSLK is also updated, then also EMMs containing the new CSLK values for the CA/DRM clients need to be generated). The CA/DRM system distributes the EMMs to the receivers 2. The CA/DRM system also generates a third key pair (SK_{i,w}, SVK_{i,w}), and distributes the public signature verification key SVK_{i,w} to all CA/DRM systems in the SimulCrypt operation. All CA/DRM systems distribute SVK_{i,w} to their receivers (e.g., using an EMM). As long as the SVK_{i,j} and SVK_{i,k} are used by the H-module 720 to generate control words CW for scrambling content, the receivers 2 will accept (or continue to operate correctly and perform correct descrambling with) CSLK-init messages signed with the signature key SK_{i,j} or SK_{i,k}. That is, during this time, the chip sets 402 can independently switch to using the new/updated CSLK-init message signed with SK_{i,k}, instead of forcing all chip sets 402 to switch at the same time. For instance, the CA/DRM system can request a group of CA/DRM clients 404 at a time to start using the new CSLK EMMs (the new CSLK-init pattern being signed with SK_{i,k}). This restricts the number of receivers 2 that can black-out simultaneously. After the CA/DRM system has requested all receivers 2 to use the new CSLK (EMMs), then receiver security can be restored by using as input to the H-module 720 instead of SVK_{i,j}. After this, the first key pair (SK_{i,j}, SVK_{i,j}) is renewed with the second key pair (SK_{i,k}, SVK_{i,k}), and receiver security is restored for the content encrypted with control words derived using SVK_{i,w}, in that the chip set will not accept CSLK-init messages signed with (the compromised) SK_{i,j}. Note that this process can be applied iteratively; the key pairs in the next iteration are (SK_{i,k}, SVK_{i,k}) and (SK_{i,w}, SVK_{i,w}).

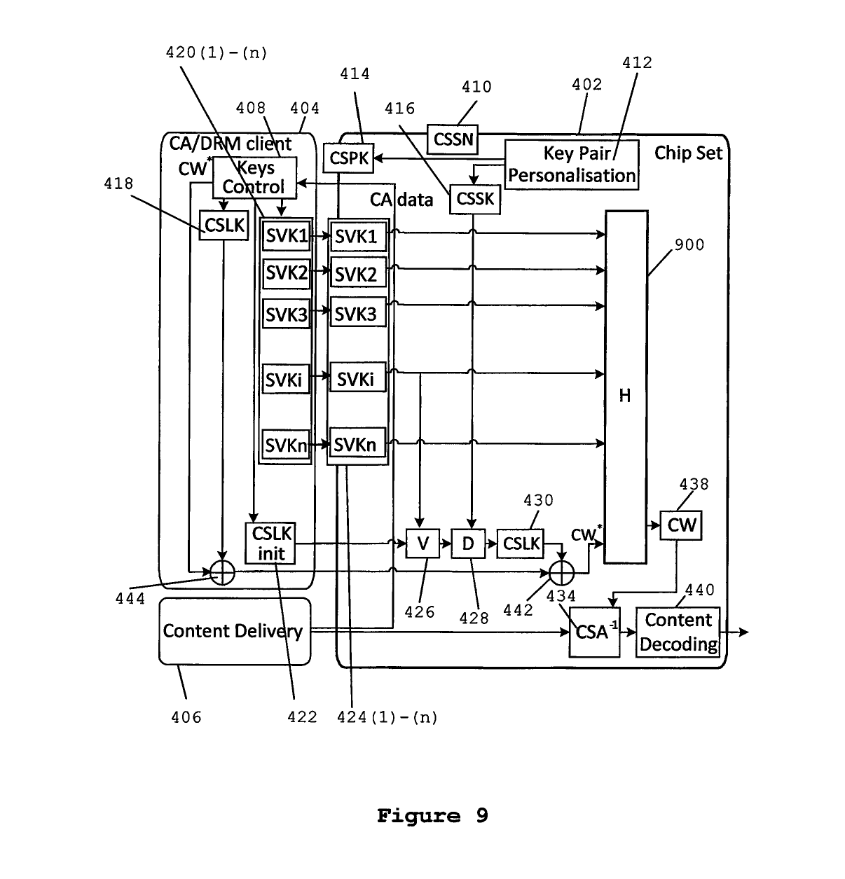

FIG. 9 schematically illustrates an example method of using a chip set. This is the same as illustrated in FIG. 4 (and therefore only the differences between the two Figures shall be described below). The system and method shown in FIG. 9 is compatible with the systems illustrated in FIGS. 7 and 8.

In particular, instead of the CA/DRM client 404 being provided with a single signature verification key SVK and providing this to the chip set 402, the CA/DRM client 404 receives the set of n signature verification keys SVK₁, . . . , SVKₙ and provides these n signature verification keys SVK₁, . . . , SVKₙ to the chip set 402 (without loss of generality, a single subscript is used to distinguish the different signature verification keys; more than one key in this set may be associated with a single CA/DRM system). The CA/DRM client 404 may store each signature verification key SVKᵢ in a corresponding memory element 420(i) of the CA/DRM client 404; the chip set 402 may store each signature verification key SVKᵢ in a corresponding memory element 424(i) of the chip set 402.

The CA/DRM client 404 is informed of the set of signature verification keys SVK₁, . . . , SVKₙ by the CA/DRM system (associated with the head-end system 4) that is servicing the receiver 2 of the CA/DRM client 404 as has been set out above.

Additionally, the H-module 432 of FIG. 4 has been replaced in FIG. 9 with an H-module 900. The H-module 900 operates in the same way as the H-module 720 of the systems illustrated in FIGS. 7 and 8. Thus, provided that the chip set 402 has been provided with legitimate/current signature verification keys SVKᵢ, . . . , SVKₙ, and provided that it has managed to successfully obtain a correct virtual control word CW*, then the output of the H-module 900 will be the same control word CW as that output by the H-module 720 in the head-end system 4 and hence the chip set 402 will be able to successfully descramble the scrambled content stream.

Preferably, a security requirement for the chip set implementation is that a CW* and a set of signature verification keys SVK₁, . . . , SVKₙ may only be provided to the H-module 900 to derive a CW (or such a derived CW may only be used for content descrambling) if the authenticity of the CSLK-init message associated with the encrypted CW* is verified with one of the keys in the set of signature verification keys SVK₁, . . . , SVKₙ and if the CSLK-init message is found to be authentic.

As the chip set 402 has a plurality of signature verification keys SVKᵢ, . . . , SVKₙ available to it, the signature verification module 426 is arranged to select the signature verification key SVKᵢ corresponding to the CSLK-init pattern that it receives from the CA/DRM client 404. For example, the head-end system 4 may assign a unique key identifier IDᵢ to SVKᵢ, and may append IDᵢ to SVKᵢ and to a CSLK-pattern signed with the corresponding signature key SKᵢ. This enables the signature verification module 426 to select the associated signature verification key SVKᵢ from the received set of signature verification keys SVK₁, . . . , SVKₙ. It will be appreciated that other mechanisms may be used to allow the signature verification module 426 to select the correct signature verification key SVKᵢ. For example, the signature verification module 426 may be arranged to try each of the signature verification keys SVK₁, . . . , SVKₙ until one of them successfully verifies the signature of the CSLK-init pattern—if none of them successfully verify this signature, then the signature verification process has failed.

In some embodiments, the set of signature verification keys SVK₁, . . . , SVKₙ and the CSLK-init message are provided to the chip set 402 with every encrypted CW*. In such embodiments, the set of signature verification keys does not need to be stored for future use inside the chip set 402.

In practice, the CA/DRM client 404 and the chip set 402 will use the key CSLK to protect the transfer of multiple virtual control words CW* from the CA/DRM client 404 to the chip set 402. To avoid time-consuming public-key operations for deriving every CW* (that is, the public-key decryption performed by the decryption module 428 using the CSSK of the chip set 402, and the signature verification performed by the signature verification module 426 using SVKᵢ), in some embodiments the key CSLK is stored (and maintained) inside the chip set 402 after it has been obtained (e.g. in the memory module 430). Thus, the public-key operations of the signature verification module 426 and the decryption module 428 only need to be performed when the chip set 402 receives a new CSLK-init pattern from the CA/DRM client 404.

In some embodiments, the set of signature verification keys SVK₁, . . . , SVKₙ to be used as input to H-module 900 is provided to the chip set 402 with every encrypted CW* from the CA/DRM client 404. In such embodiments, the set of signature verification keys does not need to be stored for future use inside the chip set 402. If the set SVK₁, . . . , SVKₙ is provided with an encrypted CW* message from the CA/DRM client 404, then before a stored CSLK is used to decrypt the encrypted CW*, some embodiments of the invention are arranged for the chip set 402 to verify whether CSLK (as stored in the memory module 430) has been loaded/obtained using one of the keys in the received set SVK₁, . . . , SVKₙ (i.e. whether the process to initially obtain and store CSLK involved the signature verification module 426 performing a signature verification process on a received CSLK-init pattern using one of the received signature verification keys SVK₁, . . . , SVKₙ). One way to achieve this is the following: after processing a CSLK-init message (received together with the associated signature verification key SVKᵢ), the chip set 402 computes a cryptographic hash value of the signature verification key SVKᵢ (that it used to verify the authenticity of the CSLK-init pattern), and the chip set 402 stores this hash value together with CSLK. For every signature verification key in the received set of signature verification keys (received together with the encrypted CW*), the chip set 402 can compute its hash value and can compare the computed hash value with the hash value stored with the CSLK required to decrypt the encrypted CW*—if this check reveals that the stored CSLK has been loaded using a valid signature verification key, then the stored CSLK may be used by the decryption module 434 to decrypt the encrypted CW*. Notice that in such embodiments a CSLK-init message only needs to be provided with the associated signature verification key SVKᵢ (instead of the set of signature verification keys). That is, in such embodiments the signature verification module 426 does not need to be arranged to select the signature verification key SVKᵢ from a set.

In some embodiments, the set of keys SVK₁, . . . , SVKₙ (and their key identifiers ID₁, . . . , IDₙ) may be stored inside the chip set 402 for future use. That is, the stored set of keys (and their key identifiers) are used to process CSLK-init messages and encrypted CW* messages provided to the chip set 402 from the CA/DRM client 404. In such an embodiment, one or more CSLK-init patterns and one or more encrypted CW* can be provided to the chip set 402. The chip set 402 can derive CSLK from a CSLK-init message using the stored set of keys SVK₁, . . . , SVKₙ and the stored set of key identifiers (used by signature verification module 426 to select the correct key from the stored set). The chip set 402 may store CSLK for future use. The chip set 402 uses the derived CSLK to obtain CW* from the encrypted CW*. Next, the chip set 402 can provide CW* and the stored set of keys SVK₁, . . . , SVKₙ as input to the H-module 900 to produce the output CW. In this way, communication costs between the CA/DRM client 404 and the chip set 402 are reduced, and overall system performance may be improved.

In some embodiments, multiple CSLK keys are stored (and maintained) inside the chip set 402 after they have been obtained (as set out above). Storing multiple CSLK keys can avoid having to perform public-key operations when switching from a current stored CSLK to another stored CSLK. This is particularly useful if the chip set 402 supports the concurrent use of multiple CA/DRM clients 404, each of which may use a different CSLK (and possibly a different set of signature verification keys), as the chip set 402 can then perform (fast) switching between CSLKs as and when desired/necessary.

If the set of keys SVK₁, . . . , SVKₙ (and their key identifiers ID₁, . . . , IDₙ, or cryptographic hash values of the keys SVK₁, . . . , SVKₙ) are stored inside the chip set 402 for future use, and if a new set of signature verification keys is provided to the chip set 402 (to be stored inside the chip set 402 instead of the set of keys SVK₁, . . . , SVKₙ), then the chip set 402 may be arranged to determine whether one or more of the stored CSLK(s) was(were) loaded using a key that is not present in the set of newly received signature verification keys. For example, the key identifier IDᵢ (or cryptographic hash value) of the signature verification key SVKᵢ used to verify the authenticity of the CSLK-init message may be stored together with CSLK. The newly received set of signature verification keys, the stored set of signature verification keys SVK₁, . . . , SVKₙ (and their key identifiers or their cryptographic hash values) and the key identifiers (or the cryptographic has values) stored with the CSLK(s) can be used to determine whether one or more of the stored CSLK(s) was(were) loaded using a key that is not present in the set of newly received signature verification keys. If there are any such CSLK(s), then the chip set 402 may be arranged to not use such a CSLK to derive a CW* (e.g., such CSLKs can be de-activated or simply deleted from the memory module 430). Alternatively, all stored CSLKs may be deleted from the memory module 430 whenever a new set of verification keys is loaded and stored inside the chip set 402. Further, if stored CSLK(s) was(were) de-activated, then the chip set 402 may be arranged to (re-)activate the CSLK(s) if a new set of signature verification keys is provided to the chip set 402, and if the associated CSLK-init pattern was verified using one of the keys in this new set. For instance, (re-)activation can be useful if the chip set 402 supports the concurrent use of multiple CA/DRM clients 404, each of which may use a different CSLK and a different set of signature verification keys, as the chip set 402 can then perform (fast) switching between CSLKs as and when desired/necessary.

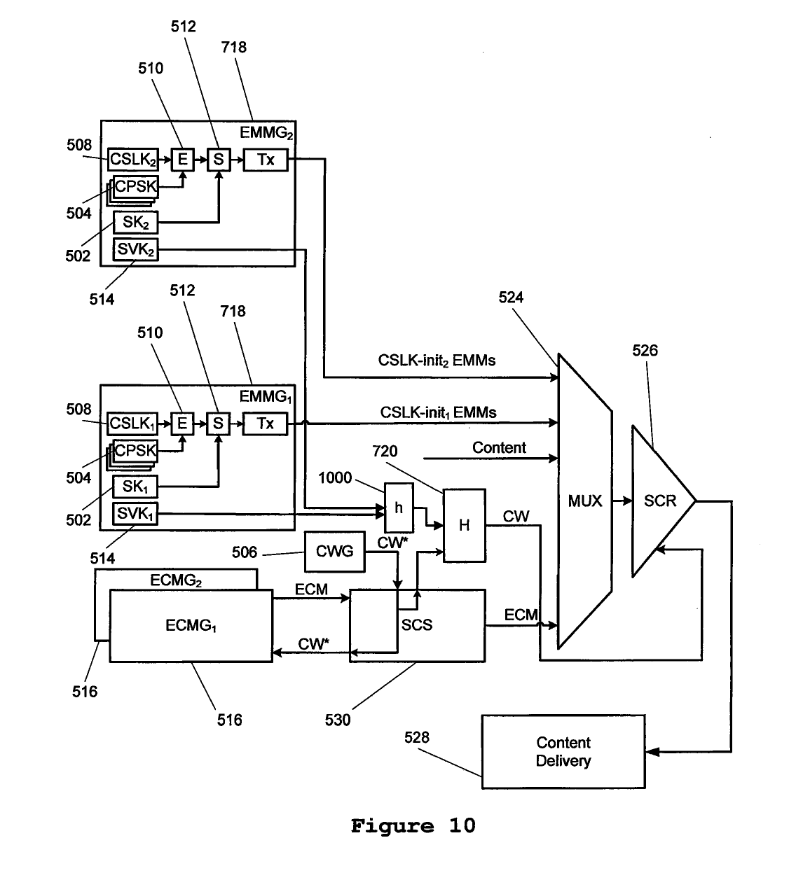

FIGS. 10-12 schematically illustrate modified versions of the systems and methods illustrated, respectively, in FIGS. 7-9. The difference is that the head-end systems 4 and the chip sets 402 illustrated include an h-module 1000. The h-module 1000 is arranged to receive, at its input, the set of signature verification keys SVK₁, . . . , SVKₙ instead of this set of signature verification keys being provided to the respective H-module 720, 900. The h-module 1000 uses its input to produce an intermediate value Z (which the chip set 402 may store for future use in a memory module 1010 of the chip set 402). The H modules 720, 900 then receive, as their input, the intermediate value Z (i.e. the value derived from the set of signature verification keys SVK₁, . . . , SVKₙ) and the virtual control word CW* and output a control word CW accordingly—in this sense, they operate in a similar manner to the H-module 432 of FIG. 4 (which has two inputs, one being a CW* and the other being a second value). The h-module 1000 may operate in exactly the same way as the H-module 720, 900 except that it does not receive a virtual control word CW* as its input. For example, the h-module 720 may merge the inputs SVK₁, . . . , SVKₙ and may then apply a cryptographic hash function h to the merged inputs to produce the output Z. The function h may also be any other suitable cryptographic function (i.e. it need not necessarily be a hash function). Possible implementations of the function h preferably have the following property: given Z, it is hard (e.g., difficult, computationally difficult, infeasible or computationally infeasible) to find or calculate or determine a key pair (SK*, SVK*) and an input to h, such that the determined signature verification key SVK* is a signature verification key in the determined input to h, and such that Z is the output of h for this input (i.e. such that providing that input to function h, or as an input to the h-module 1000, would result in outputting the value Z). In certain embodiments, “hard” may mean that an adversary may not be able to derive such an input in polynomial time or space. In other embodiments, “hard” may be defined by specifying a lower bound on the number of operations or on the size of the memory required to find such an input. As a third example, one may define “hard” by specifying an upper-bound on the probability that the property is not satisfied. Possible ways of implementing the function h include the various ways of implementing the function H (as set out above).

In general, though, for these embodiments (that make use of the h-module 1000), the joint implementation of the function H and the function h preferably has the following property: given CW, it is hard (e.g., difficult, computationally difficult, infeasible or computationally infeasible) to find or calculate or determine a key pair (SK*, SVK*) and an input to the joint implementation of the function H and the function h, such that the determined signature verification key SVK* is a signature verification key in the determined input, and such that CW is the output of the joint implementation of the function H and the function h for this input. In certain embodiments, “hard” may mean that an adversary may not be able to derive such an input in polynomial time or space. In other embodiments, “hard” may be defined by specifying a lower bound on the number of operations or on the size of the memory required to find such an input. As a third example, one may define “hard” by specifying an upper-bound on the probability that the property is not satisfied.

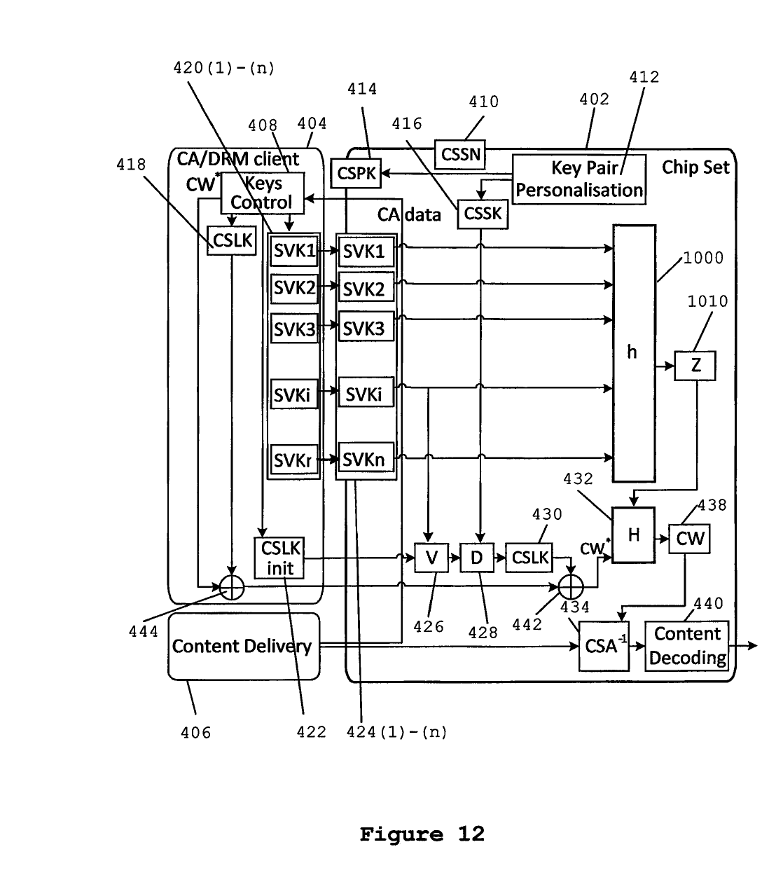

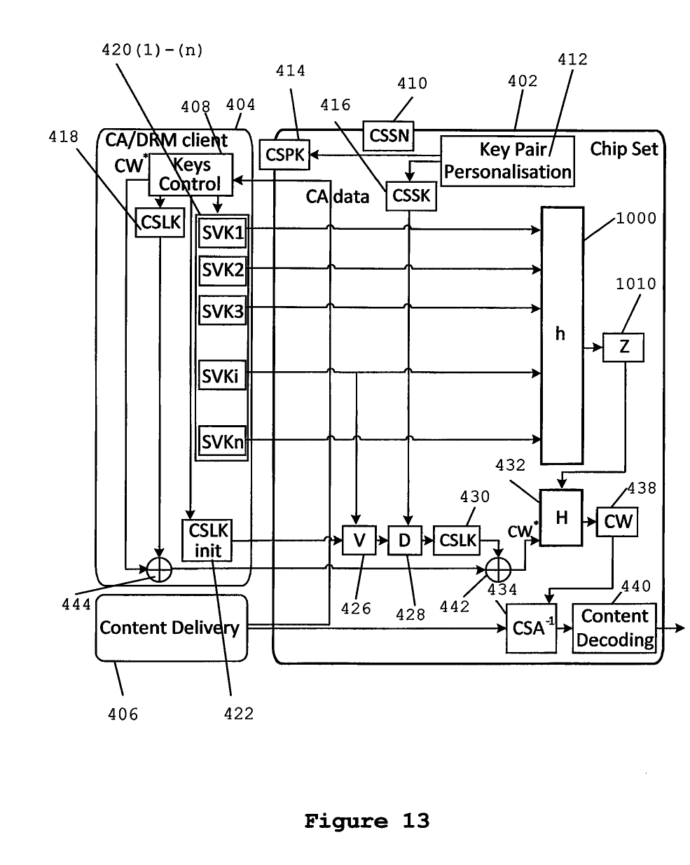

FIG. 13 schematically illustrates a variation of the chip set 402 of FIG. 12 in which the chip set 402 is not arranged to store the set of signature verification keys SVK₁, . . . , SVKₙ for future use. Instead, the chip set 402 may simply store the output of the h-module 1000, i.e. the intermediate value Z, and use this intermediate value Z as an input to the H-module 900. In this way, the storage requirements of the chip set 402 can be reduced, as storing the intermediate value Z will generally require much less memory than storing the set of signature verification keys SVK₁, . . . , SVIₙ. In addition, performance for deriving CW from CW* and Z may be improved.

In some embodiments, after processing a CSLK-init message (received together with the associated signature verification key SVKᵢ), the chip set 402 computes a cryptographic hash value of the signature verification key SVKᵢ (that it used to verify the authenticity of the CSLK-init pattern), and the chip set 402 stores this hash value together with CSLK. If a set of signature verification keys is provided to the chip set 402 (used as input to the h-module 1000, producing a value Z to be stored inside the chip set 402 for deriving control words), then the chip set 402 may compute the hash value of each signature verification key in the set, and use the computed hash values and the stored hash values (one stored hash value with every stored CSLK) to determine whether one or more of the stored CSLK(s) was(were) loaded using a key that is present in the set of received signature verification keys. As before, such a mechanism can be used to activate, deactivate or delete CSLK(s), based on the received set of signature verification keys.

In some embodiments, after the chip set 402 receives a set of signature verification keys SVK₁, . . . , SVKₙ, it computes a cryptographic hash value for each of these keys, and stores these values with the value of Z for future use. For example, if a CSLK-init message is received together with the associated signature verification key SVKᵢ, the chip set 402 can compute a cryptographic hash value of the signature verification key SVKᵢ. Next, the chip set compares the computed hash value with the stored hash values, and only processes the CSLK-init message if (at least) one of the stored hash values is equal to the computed hash value. In this way CSLK-init messages are only processed if SVKᵢ is an element of the set of signature verification keys SVK₁, . . . , SVKₙ used to produce the stored Z.

In some embodiments, a set of cryptographic hash values (comprising, for each key in the set of signature verification keys SVK₁, . . . , SVKₙ, a corresponding cryptographic hash value derived from that signature verification key) is provided to the function H (or the function h if present) instead of the set of signature verification keys SVK₁, . . . , SVKₙ. In such embodiments, the chip set 402 does not need to receive (or store) the set of signature verification keys; the chip set 402 only needs to receive the set of cryptographic hash values and the signature verification key associated with a CSLK-init message. The chip set 402 can compute the cryptographic hash value of the received signature verification key (received with the CSLK-init message), and compare this hash value with the cryptographic hash values in the received (or stored) set of cryptographic hash values to determine if the signature verification key provided with the CSLK-init message is associated with one of the signature verification keys in the set SVK₁, . . . , SVKₙ. In one embodiment, the CA/DRM (head-end) system can compute the set of cryptographic hash values. Next, the CA/DRM (head-end) system can send the set of cryptographic hash values to its CA/DRM clients. In such embodiments, the CA/DRM system only needs to provide the signature verification key(s) associated with that CA/DRM system to the CA/DRM clients associated with that CA/DRM system (to process CSLK-init messages associated with that CA/DRM system). Communication costs, storage costs and computation costs may be reduced in such embodiments. Alternatively, it may be the CA/DRM client that computes the set of cryptographic hash functions (having received the set of signature verification keys SVK₁, . . . , SVKₙ).

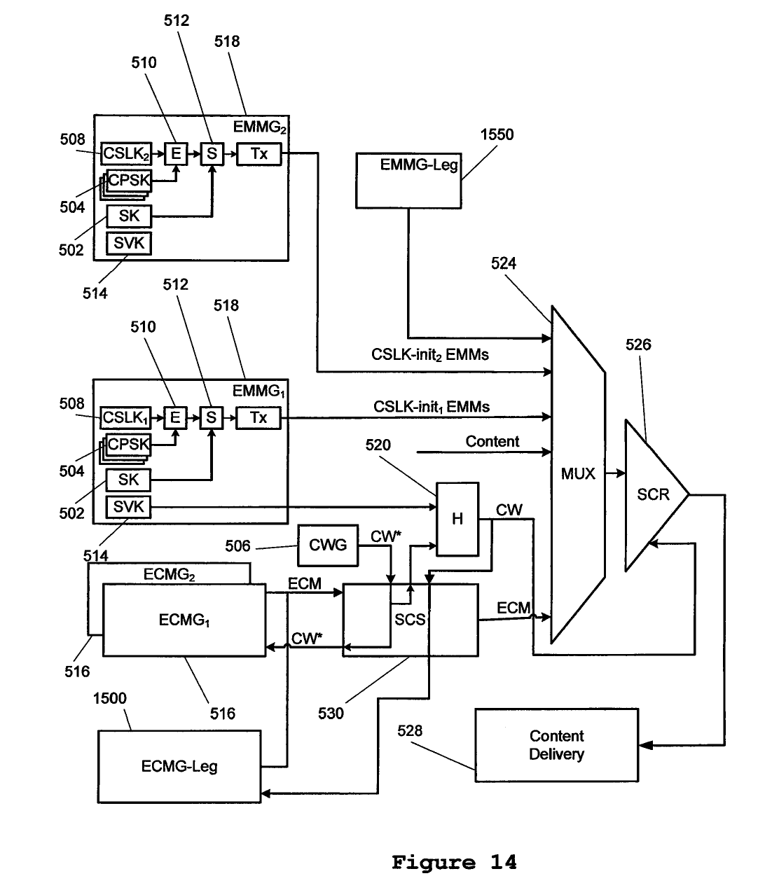

FIGS. 14-18 correspond to FIGS. 6, 7, 8, 10 and 11 respectively. However, in the systems shown in FIGS. 14-18, there is one or more legacy ECM generators 1500 and one or more legacy EMM generators 1550. The legacy ECM generators 1500 and the legacy EMM generators 1550 correspond to one or more CA/DRM systems associated with the head-end system 4 that do not make use of the methods described above for protecting the confidentiality and authenticity of control words (that is, these CA/DRM systems do not make use of CW*). Thus, the legacy ECM generators 1500 are arranged to receive the CW generated by the H-module 900 and generate ECMs based on the CW—this is in contrast to the ECM generators 516 which generate ECMs based on the virtual control word CW*. In the systems shown in FIGS. 14-18, the legacy ECM generators 1500 are arranged to receive the CW via the SimulCrypt synchroniser 530, but it will be appreciated that this is not essential. Similarly, the legacy EMM generators 1550 generate EMMs and provide those EMMs to the multiplexer 524—they do not provide an input to the H-module 900 or the h-module 1000.

In some embodiments, the output of the function H may include more than one value to be used in the content (de-)scrambling mechanism. For instance, the output of the H-module can consist of the virtual control word CW* and a second key derived from CW* and the set of keys SVK₁, . . . , SVKₙ (or the value Z if h-module 1000 is used). These two derived keys can then be used in a super-scrambling solution where one key is used in a first scrambling step and the other key is used in a second scrambling step at the head-end system 4. The chip set 402 may be modified to perform two corresponding descrambling steps instead of one. In general, the output of the H-module may include multiple content (de-)scrambling keys that can be used in a super-scrambling solution consisting of multiple content (de-)scrambling steps. The output of the function H may also include more than one control word. Each of these control words can be used for (de-)scrambling an associated piece of content. For instance, the output of the H-module can consist of two control words. The first control word can be used for (de-)scrambling a first piece of content, and the second control word can be used for (de-scrambling) a second piece of content. In embodiments in which the output of the function H includes more than one value to be used in the content (de-)scrambling mechanism, possible implementations of the function H preferably have the following property: given an output Y, it is hard (e.g., difficult, computationally difficult, infeasible or computationally infeasible) to find or calculate or determine a key pair (SK*, SVK*) and an input to H, such that the determined signature verification key SVK* is a signature verification key in the determined input to H, and such that Y is the output of H for this input. (If the h-module 1000 is used, then the preferred property can be adapted as mentioned before). In addition, one may require that the preferred property of the function H holds independently for parts of the output, e.g., for all keys associated with one piece of content. Notice that this is a stronger property which is useful, but not strictly necessary, as the weaker property (i.e., the property described above on the output Y) already implies that the descrambling of at least one of the pieces of content associated with the output of H will fail.

In some embodiments, a first subset of the set of signature verification keys SVK₁, . . . , SVKₙ (or hash values thereof) is provided to the function h, and the input of the function H comprises both the output of the function h and a second subset of the set of signature verification keys SVK₁, . . . , SVKₙ (or hash values thereof). These two subsets may each comprise one or more (or all) of the signature verification keys SVK₁, . . . , SVKₙ. The union of these two subsets is the entire set of signature verification keys SVK₁, . . . , SVKₙ. These two subsets may or may not overlap.

In some embodiments, the (bit-)length of a virtual CW* may be larger than the (bit-)length of a CW, e.g. if the output of the H-module includes more than one control word.

In some embodiments, the function H and/or the function h may receive one or more additional inputs and generate their respective outputs based on those one or more additional inputs.

While generic public-key cryptography modules have been described and used in the above-mentioned embodiments of the invention, it will be appreciated that any other suitable cryptographic operations and infrastructure may be used as long as the authenticity and confidentiality of a CW loading message are provided. As an example, the authenticity mechanism may use a symmetric scheme in which both SK and SVK are secret keys. A well known example of such a system is RSA with a randomly selected encryption (or decryption) exponent, both of which are kept secret. If an authenticity mechanism is used in which SVK is a secret key, then preferably the SVK is transmitted in encrypted form to the chip set 402, e.g., using the chip set secret key CSSK of the associated chip set 402 as an encryption key. However, note that some of the advantages described in this disclosure do not apply if a symmetric authenticity mechanism is used. It may also be possible to insert additional key layers to the methods and systems described above, or to remove a key layer in the methods and systems described above.

The various symmetric and asymmetric encryption/decryption modules and schemes mentioned above may make use of any symmetric or asymmetric encryption/decryption algorithms currently known or devised in the future. Similarly, the various signature generation and verification modules and schemes mentioned above may make use of any signature generation and verification algorithms currently known or devised in the future.

It will be appreciated that embodiments of the invention may be implemented using a variety of different information processing systems. In particular, although the Figures and the discussions thereof provide exemplary architectures, these are presented merely to provide a useful reference in discussing various aspects of the invention. Of course, the description of the architecture has been simplified for purposes of discussion, and it is just one of many different types of architecture that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program,” as used herein, may be a sequence of instructions designed for execution on a computer system, and may include a subroutine, a function, a procedure, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method for securely obtaining a control word in a chip set of a receiver, said control word for descrambling scrambled content received by the receiver, 5 the method comprising, at the chip set:
receiving a secured version of a virtual control word from a conditional access/digital rights management client communicably connected to the chip set;
obtaining the virtual control word from the secured version of the virtual control word; and
using a first cryptographic function to produce a given output from an input that comprises the virtual control word and either a plurality of signature verification keys or one or more values derived from a plurality of signature verification keys, each signature verification key being associated with a conditional access/digital rights management system, the given output comprising at least one control word, wherein the first cryptographic function has the property that it is infeasible to determine a key pair including a signature key and a signature verification key and an input for the first cryptographic function comprising the determined signature verification key or one or more values derived, at least in part, from the determined signature verification key, such that the first cryptographic function produces the given output from the determined input.

2. The method according to claim 1, comprising receiving and storing the signature verification keys of the plurality of signature verification keys, wherein said first cryptographic function is arranged to use said stored signature verification keys as a part of the input to the first cryptographic function.

3. The method according to claim 1, comprising:
receiving the plurality of signature verification keys;
generating a derived value from the received plurality of signature verification keys; and
storing the generated derived value;
wherein said first cryptographic function is arranged to use said stored derived value as a part of the input to the first cryptographic function.

4. The method according claim 1, comprising:
receiving, at the chip set, a secured version of a chip set load key, wherein the secured version of the chip set load key is secured to protect the authenticity and confidentiality of the chip set load key; and
obtaining the chip set load key from the secured version of the chip set load key.

5. The method according to claim 4, wherein the secured version of the virtual control word is a virtual control word encrypted using the chip set load key; and
wherein obtaining the virtual control word from the secured version of the virtual control word comprises using the chip set load key to decrypt the secured version of the virtual control word.

6. The method according to claim 4, wherein the secured version of the chip set load key comprises the chip set load key encrypted using a public key associated with the chip set and a signature based on the chip set load key using a Signature key associated with a conditional access/digital rights management system, wherein obtaining the chip set load key from the secured version of the chip set load key comprises:
verifying the signature using a signature verification key corresponding to the signature key associated with the conditional access/digital rights management system, wherein the signature verification key is one of the plurality of signature verification keys; and
decrypting the encrypted chip set load key using a secret key associated with the chip set, the secret key corresponding to the public key associated with the chip set.

7. The method according to claim 6, comprising the chip set storing the chip set load key obtained from the secured version of the chip set load key so that the stored chip set load key can be used to decrypt secured versions of virtual control words received by the chip set.

8. The method according to claim 7, comprising:
receiving the plurality of signature verification keys along with the secured version of the virtual control word; and
determining whether the signature based on the stored chip set load key was verified using one of the received signature verification keys and, if it is determined that the signature based on the stored chip set load key was not verified using one of the received signature verification keys, not using the stored chip set load key to decrypt the secured version of the virtual control word received by the chip set.

9. The method according to claim 6, in which the receiver is one receiver in a plurality of receivers, each receiver in the plurality of receivers having a corresponding chip set that has an associated secret key, wherein the secret keys associated with the chip sets of the receivers in the plurality of receivers are different from each other.

10. A method for providing a control word to a chip set of a receiver, the control word to enable the receiver to descramble scrambled content transmitted to the receiver, the method comprising:
generating a virtual control word at a head-end system;
transmitting the virtual control word from the head-end system to a conditional access/digital rights management client via the receiver, wherein the conditional access/digital rights management client is communicably connected to the chip set;
using a first cryptographic function to produce a given output from an input that comprises the virtual control word and either a plurality of signature verification keys or one or more values derived from a plurality of signature verification keys, each signature verification key being associated with a conditional access/digital rights management system, the given output comprising at least one control word, wherein the first cryptographic function has the property that it is infeasible to determine a key pair including a signature key
and a signature verification key and an input for the first cryptographic function comprising the determined signature verification key or one or more values derived, at least in part, from the determined signature verification key, such that the first cryptographic function produces the given output from the determined input;
scrambling content using the control word to produce scrambled content; and
transmitting the scrambled content to the chip set.

11. The method according to claim 10, wherein the receiver is associated with a conditional access/digital rights management system, the method comprising transmitting to the chip set a secured version of a chip set load key, wherein the secured version of the chip set load key is secured to protect the authenticity and confidentiality of the chip set load key, the chip set load key to enable the receiver to access the virtual control word.

12. The method according to claim 11, wherein the secured version of the chip set load key comprises the chip set load key encrypted using a public key associated with the chip set and a signature based on the chip set load key using a signature key associated with the conditional access/digital rights management system associated with the receiver and corresponding to one of the plurality of signature verification keys.

13. The method according to claim 10, comprising transmitting the control word from the head-end system to a second conditional access/digital rights management client via a second receiver, wherein the second conditional access/digital rights management client is communicably connected to a second chip set of the second receiver.

14. The method according to claim 10, wherein at least two of the signature verification keys in the plurality of signature verification keys are associated with the same conditional access/digital rights management system.

15. The method according to claim 10, wherein at least two of the signature verification keys in the plurality of signature verification keys are associated with different conditional access/digital rights management systems.

16. The method according to claim 10, in which a derived value is produced by providing the plurality of signature verification keys to a second cryptographic function, wherein the second cryptographic function has the property that it is infeasible to generate a key pair including a signature key and a signature verification key and an input for the second cryptographic function comprising the generated signature verification key such that the second cryptographic function produces that derived value from the generated input.

17. The method according to claim 10, in which the one or more derived values comprise, for each signature verification key in the plurality of signature verification keys, a corresponding cryptographic hash value of that signature verification key.

18. A chip set, for a receiver, for securely obtaining a control word, the chip set arranged to carry out a method according to claim 1.

19. A head-end system of a content delivery network, the head-end system arranged to carry out a method according to claim 10.

20. A receiver comprising the chip set according to claim 18.

21. A system comprising the head-end system according to claim 19.

22. A non-transitory computer readable medium having stored thereon instructions, when executed, carries out a method according to claim 1.

23. A system comprising one or more chip sets according to claim 18.
